(19) United States
(12) Patent Application Publication
(10) Pub. No.: US 2025/0253325 A1
(43) Pub. Date: Aug. 7, 2025

(54) BATTERY CELL AND RELATED METHODS

(71) Applicant: BASIC NECESSITIES LLC, New Lenox, IL (US)

(72) Inventors: Brendon Stewart Cop, Meaford (CA); Robert Bailey Topham, Fortune Bridge (CA)

(21) Appl. No.: 19/046,688

(22) Filed: Feb. 6, 2025

Related U.S. Application Data
(60) Provisional application No. 63/550,309, filed on Feb. 6, 2024.
(60) Provisional application No. 63/660,601, filed on Jun. 17, 2024.
(60) Provisional application No. 63/686,131, filed on Aug. 22, 2024.

(51) Int. Cl. H01M 4/46; H01M 4/02; H01M 4/583; H01M 4/62; H01M 4/66; H01M 4/76; H01M 10/0565; H01M 12/08

(52) U.S. Cl. CPC H01M 4/466; H01M 4/583; H01M 4/628; H01M 4/663; H01M 4/762; H01M 10/0565; H01M 12/08; H01M 2004/027; H01M 2004/028

(57) ABSTRACT

In one aspect, a battery is provided having an anode, a cathode and an electrolyte between the anode and the cathode. The anode includes an anode body is formed of a magnesium alloy having a percent by weight ratio in the range of about 77.0-99.8% wt. magnesium, 0.1-8.0% wt. aluminum, 0.1-5.0% wt. zinc, 0-5.0% wt manganese, and 0-5.0% wt. iron. The cathode includes a cathode body.

### CROSS-REFERENCE TO RELATED APPLICATIONS

This application claims the benefit of U.S. Provisional Application No. 63/686,131, filed Aug. 22, 2024, and U.S. Provisional Application No. 63/660,601, filed Jun. 17, 2024, and U.S. Provisional Application No. 63/550,309, filed Feb. 6, 2024, all of which are hereby incorporated herein by reference in their entireties.

### FIELD

This disclosure relates to batteries and, in particular, to magnesium-air batteries.

### BACKGROUND

Lithium-ion batteries are currently used in many applications. Lithium-ion batteries, however, have many shortcomings including limitations in energy density, their environmental impact, their charging efficiency, their fire safety, and their recyclability. Magnesium batteries have been recognized as a potential alternative to lithium-based batteries. Magnesium batteries are particularly promising due to the high-capacity of magnesium metal that is used as the anode.

While magnesium batteries have been recognized for their potential, there are several challenges to developing a practical rechargeable magnesium battery. One challenge is that existing cathodes are prone to dendrite formation. Dendrite formation can result in decreased battery performance, decreased battery life, corrosion of the battery, and a short circuit.

Many existing electrolytes do not sufficiently reduce the energy required to move the magnesium ions through the electrolyte. As a result, a significant amount of energy is needed to cause electrons and ions to flow, which can result in parasitic reactions that, for example, compete with the process of recharging.

Furthermore, in many magnesium-based batteries, the discharge products are difficult to separate into ions to allow for recharging of the battery, which hampers output of the battery and slows down the charge cycle. Currently there are few known viable organic electrolytes that are compatible with a magnesium-metal anode. As a result, existing solutions often require an electrolyte and/or catalyst that may have significant environmental impacts when creating and disposing of the battery. Moreover, conventional electrolytes, such as carbonate, react with magnesium, which creates an oxidation barrier on the surface of magnesium that inhibits the battery from recharging.

Still further, magnesium metals are difficult to use in batteries because of their high reactivity. Since magnesium is chemically unstable in its elemental (unbonded) state, it has a propensity to react with chemicals in its environment, primarily oxygen, to attain chemical stability. For example, when exposed to ambient atmospheric conditions, magnesium reacts with oxygen to form a magnesium oxide (MgO) which results in an oxidation film that blocks redox reactions and reduces the performance of the battery.

### BRIEF DESCRIPTION OF THE DRAWINGS

FIG. 1A is a top perspective view of a magnesium battery cell according to one embodiment.

FIG. 1B is a bottom perspective view of the magnesium battery cell of FIG. 1A.

FIG. 1C is a cross-sectional view of the magnesium battery cell of FIG. 1A taken across line 1C-1C of FIG. 1A.

FIG. 1D is a perspective, cross-section of the magnesium battery cell shown in FIG. 1C shown without an internal air chamber, FIG. 1D showing the interconnection of the anode and the cathode.

FIG. 1E is a cross-sectional view of the magnesium battery cell of FIG. 1A shown without the internal air chamber, FIG. 1E taken across line 1E-1E of FIG. 1A.

FIG. 2 is a schematic diagram illustrating portion A of FIG. 1C.

FIG. 3 is a perspective view of a battery comprising a plurality of magnesium battery cells of FIG. 1A.

FIG. 4 is a diagram illustrating the operation of the magnesium battery cell of FIG. 1A.

FIG. 5 is a side cross-sectional view of a magnesium battery cell according to another embodiment.

FIG. 6A is a schematic diagram of a cross-section of a central protrusion of the cathode of the magnesium battery cell of FIG. 5.

FIG. 6B is a schematic diagram of a cross-section of an outer protrusion of the cathode of the magnesium battery cell of FIG. 5.

FIG. 7A is a schematic diagram of a cross-section of the central protrusion of the cathode according to another embodiment, FIG. 7A showing gaps between layers of the central protrusion.

FIG. 7B is a schematic diagram of a cross-section of the outer protrusion of the cathode according to another embodiment, FIG. 7B showing gaps between layers of the outer protrusion.

FIG. 8A is a top perspective view of a magnesium battery cell having a coin cell configuration.

FIG. 8B is an exploded view of the magnesium battery cell of FIG. 8A.

FIG. 9A is a cross-sectional view of the magnesium battery cell of FIG. 8A taken along lines 9A-9A of FIG. 8A.

FIG. 9B is a perspective view of the cross-section of the magnesium battery cell of FIG. 8A shown in FIG. 9A.

FIG. 10A is a bottom perspective view of a cathode assembly of the magnesium battery cell of FIG. 8A.

FIG. 10B is a top perspective view of the cathode assembly of FIG. 10A.

FIG. 11 is a perspective view of an anode of the magnesium battery cell of FIG. 8A.

FIG. 12 is a bottom perspective view of the magnesium battery cell of FIG. 8A showing an air interface.

FIG. 13A is a top view of a battery case for the magnesium battery cell of FIG. 8A according to another embodiment.

FIG. 13B is a perspective, cross-sectional view of the battery case of FIG. 13A.

FIG. 14 illustrates a battery case for the magnesium battery cell of FIG. 8A according to another embodiment.

FIG. 15 illustrates a battery case for the magnesium battery cell of FIG. 8A according to another embodiment.

FIG. 16 is a perspective, cross-sectional view of the battery case of FIG. 15.

FIG. 17 is a perspective, cross-sectional view of a battery case for the magnesium battery cell of FIG. 8A according to another embodiment.

FIG. 18 is a perspective view of a magnesium battery cell having a prismatic configuration.

FIG. 19 is a perspective view of the magnesium battery cell of FIG. 18 with an interface portion removed.

FIG. 20A is a perspective view of an anode-cathode laminate assembly of the magnesium battery cell of FIG. 18 including an anode and a cathode laminated to a separator.

FIG. 20B is an enlarged view of portion B of the anode-cathode laminate assembly shown in FIG. 20A.

FIG. 21 illustrates the anode-cathode laminate assembly of FIG. 20A formed into a flat jellyroll configuration.

FIG. 22 illustrates the anode-cathode laminate assembly of FIG. 20A formed into a cylindrical jellyroll configuration.

FIG. 23 is a perspective view of the cathode assembly of the anode-cathode laminate assembly of FIG. 20A.

FIG. 24 is a perspective view of the anode assembly of the anode-cathode laminate assembly of FIG. 20A.

FIG. 25 is a top perspective, cross-sectional view of a magnesium battery cell having a coin cell configuration according to another embodiment.

FIG. 26A is a bottom perspective, cross-sectional view of a cathode assembly of the magnesium battery cell of FIG. 25.

FIG. 26B is a is an enlarged view of portion C of the cathode assembly of FIG. 26A.

FIG. 27A is a top perspective, cross-sectional view of a coin format magnesium battery cell having a cathode assembly according to another embodiment.

FIG. 27B is a cross-sectional view of a portion of the coin format magnesium battery cell of FIG. 27A.

FIG. 27C is a perspective, cross-sectional view of the cathode assembly of the coin format magnesium battery cell of FIG. 27A.

FIG. 28A is a perspective view of a portion of an anode-cathode laminate assembly for a magnesium battery cell having a cathode assembly according to another embodiment.

FIG. 28B is a perspective view of a portion of the cathode assembly of the anode-cathode laminate assembly of FIG. 28A.

FIG. 29A is a top perspective, cross-sectional view of a coin format magnesium battery cell having a solid-state electrolyte.

FIG. 29B a cross-sectional view of a portion of the coin format magnesium battery cell of FIG. 29A.

FIG. 30 a perspective view of a portion of an anode-cathode laminate assembly for a magnesium battery cell according to another embodiment having a solid-state electrolyte sheet.

FIG. 31A is a top perspective view of a cylindrical format magnesium battery cell according to another embodiment.

FIG. 31B is a cross-section view of the battery cell of FIG. 31A.

FIG. 31C is a perspective, cross-sectional view of a portion of the battery cell of FIG. 31A adjacent to an end cap.

FIG. 31D is a perspective, cross-sectional view of a portion of the battery cell of FIG. 31A opposite the end cap.

FIG. 32A is a top perspective view of an end cap for a cylindrical configuration magnesium battery cell.

FIG. 32B is a bottom perspective view of a housing for a cylindrical configuration magnesium battery cell including openings to permit airflow therethrough.

FIG. 33 is a bottom view of a cylindrical configuration magnesium battery cell having a porous film closing an end of the housing.

FIG. 34 is a schematic diagram of a hybrid solid state electrolyte for a battery cell.

### DETAILED DESCRIPTION

In some embodiments, a battery cell is provided including an anode having an anode body formed of a magnesium alloy having a percent by weight ratio in a range of about 77.0-99.8% wt. magnesium, 0.1-8.0% wt. aluminum, 0.1-5.0% wt. zinc, 0-5.0% wt manganese, and 0-5.0% wt. iron. The battery cell further includes a cathode including a cathode body and an electrolyte between the anode and the cathode. In some embodiments, the cathode includes an air chamber. In some embodiments, the magnesium alloy of the anode includes one or more of AZ31, AZ61, and MA8M06. In some embodiments, the anode is a first layer in a laminate assembly and the cathode is a second layer in the laminate assembly. In some embodiments, the battery cell has a cylindrical format, a pouch format, a prismatic format, or a coin cell format.

In some embodiments, a battery cell is provided that has an anode formed of a magnesium alloy and further includes a percent by weight ratio of one or more of 0.1-2% wt. germanium, 0.1-5% wt. calcium, 0.1-3% wt. samarium, 0.1-5% wt. gallium, and 0.1-3% wt. indium.

In some embodiments, a battery cell is provided that has an anode formed of a magnesium alloy and further includes a percent by weight ratio in a range of about 0.7-2.0% wt. manganese and/or 0.1-0.7% wt. iron.

In some embodiments, a battery cell is provided that has an anode that includes a foam body formed of the magnesium alloy. In some embodiments, the foam body of the anode is a macrofoam. In some embodiments the foam body of the anode is a microfoam. In some embodiments, the foam body of the anode is a nanofoam.

In some embodiments, a battery cell is provided that has a cathode that includes a foam body. In some embodiments, the foam body includes graphene, graphite, doped graphene, or doped graphite. In some embodiments, the foam body of the cathode is a macrofoam. In some embodiments the foam body of the cathode is a microfoam. In some embodiments, the foam body of the cathode is a nanofoam.

In some embodiments, a battery cell is provided that includes a cathode, an electrolyte, and a liquid barrier between the electrolyte and the cathode body that inhibits a liquid of the electrolyte from contacting the cathode body.

In some embodiments, a battery cell is provided that includes a cathode and an electrolyte. The cathode includes a collecting layer disposed at an interface of the cathode and the electrolyte. The collecting layer includes openings to permit fluid flow therethrough.

In some embodiments, a battery cell is provided that includes a cathode body and an electrolyte, where the cathode body includes a porous substrate such as a porous carbonaceous substrate. As one example, the porous substrate is a carbon paper. The porous substrate permits air to move in the cathode, e.g., via the pores or passageways therein. The battery cell further includes a catalyst, a liquid barrier, and/or a collector layer between the cathode body and the electrolyte. The catalyst, liquid barrier, and/or collecting layer(s) is dispersed over the porous cathode body, e.g., covering the outer surface of the porous cathode body. For example, the material of the catalyst layer (e.g., manganese oxide) and/or collecting layer (e.g., doped graphene powder/nanofoam) may be mixed with a binder and disposed over, such as cast on, the porous substrate of the cathode, e.g., to coat the porous cathode body. The catalyst, liquid barrier, and/or collecting layer may thus be a single, homogenous layer comprised of the catalyst, liquid barrier, and/or collecting layer materials.

In some embodiments, a battery cell is provided that includes a cathode body having a percent by weight ratio in a range of about 0-90% wt. doped graphene and/or manganese oxide, 0-10% wt. carbon substrate, and 0-10% binding agent. The binding agent may include for example, polyvinylidene fluoride and/or polyvinylidene difluoride.

In some embodiments, a battery cell is provided that includes a cathode body having a percent by weight ratio in a range of about 0-90% wt. graphene and/or a crushed graphene nanofoam, 0-10% wt. carbon substrate, and 0-10% wt. binding agent. The binding agent may include for example, polyvinylidene fluoride and/or polyvinylidene difluoride. As an example, the cathode body may include about 45% wt. N-doped graphene nanopowder, 45% wt. manganese oxide powder, 5% wt. carbon paper, and 5% wt. PVDF binder.

In some embodiments, a battery cell is provided that has a cathode and an electrolyte. The cathode includes a collecting layer disposed at an interface of the cathode and the electrolyte. The collecting layer is comprised of one or more of a nickel, carbon, graphite, graphene, doped graphite, and a doped graphene. In some embodiments, the doped graphite or doped graphene are doped with an elemental doping agent. In some embodiments, the collecting layer includes one or more of an aluminum-graphene alloy, an aluminum-doped graphene alloy, a copper-graphene alloy, and a copper-doped graphene alloy.

In some embodiments, a battery cell is provided that includes a solid separator between the anode and cathode. The separator may absorb, such as be saturated (fully or partially) with, an aqueous electrolyte solution. In some embodiments, the separator is one or more of an aerogel or a hydrogel. In some embodiments, the separator includes a graphene aerogel, a graphene hydrogel, a doped graphene aerogel, a doped graphene hydrogel, and/or agar gel. In some embodiments, the separator includes a graphene aerogel or graphene hydrogel doped with carbon nanotubes. In some embodiments, the separator has a percent by weight ratio in a range of about 0.1-10% wt. agar, 0.1-20% sodium chloride, 0.1-60% wt. ionic salt with a complexing agent, 0-10% wt. doped graphene powder, and the balance water. For example, the ionic salt may include a central metal ion. As examples, the central metal ion includes one or more of lithium, magnesium, potassium, sodium and zinc and the complexing agent includes one or more of nitrate, ammonium, sulfate, phosphate, acetate, chloride, and hydrogen. As examples, the ionic salt with a complexing agent may be lithium chloride, magnesium sulfate, magnesium chloride, magnesium phosphate, magnesium nitrate, magnesium acetate, lithium bis(trifluoromethanesulfonyl)imide, lithium hexafluorophosphate, lithium nitrate, lithium bis(fluorosulfonyl)imide, and/or lithium tetrafluoroborate salts. In some embodiments, the electrolyte may include ionic salt(s) with a complexing agent in water, such as those described above with respect to the separator. In some embodiments, the electrolyte includes a solution having a percent by weight ratio of about 0.1-20% wt. sodium chloride, 0.1-70% wt. ionic salt with a complexing agent, and 10-99.8% wt. water. Inclusion of such ionic salts with a complexing agent creates a highly hygroscopic, chemically stable additive for the electrolyte and/or separator, which aids to retain water in the electrolyte and/or separator.

In some embodiments, a battery cell is provided that has a battery cell terminal and a cathode. In some embodiments, the cathode may include a current collecting layer in electrical communication with the battery cell terminal. In some embodiments, the current collecting layer is comprised of one or more of aluminum (e.g., pure aluminum), copper (e.g., pure copper) carbon, graphite, graphene, doped graphene, aluminum-graphene, aluminum-doped graphene, copper-graphene and a copper-doped graphene. In embodiments where the current collecting layer includes a metal, the current collecting layer includes one of a foil and a microfoil. In embodiments where the current collection layer is non-metal, the current collecting layer is a film disposed on a cathode body of the cathode.

In some embodiments, a battery cell is provided that has an anode including an anode body, a cathode including a cathode body, and an electrolyte between the anode and the cathode. In some embodiments, the anode may include an anode current collector disposed over a side of the of the anode body opposite the electrolyte and the cathode may include a cathode current collector disposed over a side of the cathode body opposite the electrolyte. In some embodiments, the anode current collector includes one of more of aluminum, copper, aluminum-graphene, aluminum-doped graphene, copper-graphene, copper-doped graphene, carbon, graphite, graphene, and doped graphene. In some embodiments, the cathode current collector includes one of more of aluminum, copper, aluminum-graphene, aluminum-doped graphene, copper-graphene, copper-doped graphene, carbon, graphite, graphene, and doped graphene.

In some embodiments, a battery cell is provided that has a cathode and an electrolyte, the cathode including a catalyst disposed at an interface of the cathode with the electrolyte. In some embodiments, the catalyst includes one or more of a zinc phosphate and a manganese oxide.

In some embodiments, a battery cell is provided that includes an electrolyte solution having a percent by weight ratio of 0.1-10% wt. NaCl, 0.1-5.0% wt. graphene or doped graphene, and 85-99.8% wt. water. In some embodiments, the graphene or doped graphene component is water-soluble.

In some embodiments, a battery cell is provided that includes a solid-state electrolyte. In some embodiments, the electrolyte is one or more of an aerogel or a hydrogel. In some embodiments, the electrolyte includes a graphene aerogel, a graphene hydrogel, a doped graphene aerogel, a doped graphene hydrogel, and/or agar gel. In some embodiments, the electrolyte includes a graphene aerogel or graphene hydrogel doped with carbon nanotubes.

In some embodiments, a battery cell is provided that includes a housing about a cathode of the battery cell, the housing including openings to permit air to flow to and from the cathode. In some embodiments, the housing includes a liquid barrier layer over the openings to inhibit fluid from flowing through the openings of the housing. In some embodiments, the openings of the housing are sized to permit oxygen to pass through the openings of the housing and to inhibit water from passing through the openings of the housing.

In some embodiments, a battery cell is provided that includes a cathode having a cathode body comprised of a magnesium alloy having a percent by weight ratio in a range of about 92.0-97.9% wt. magnesium, 2.0-7.2% wt. aluminum, and 0.1-5.0% wt. zinc. In some forms, the magnesium alloy of the cathode body includes one or more of AZ31, AZ61, and MA8M06.

In some embodiments, a battery cell is provided that includes a housing about an anode, a cathode, and an electrolyte, where the housing has a plurality of microscopic openings sized to permit air to flow through the housing and inhibit water from flowing through the housing. In some embodiments, the plurality of microscopic openings of the housing have a diameter of about 2.75 angstroms or less.

In some embodiments, a battery cell is provided that includes a housing and a liquid barrier layer. The housing includes at least one opening. The liquid barrier layer extends across the at least one opening of the housing and permits air to flow therethrough while inhibiting liquid from flowing therethrough.

In some embodiments, a battery cell is provided including an anode and a cathode. The anode has an anode base and at least one protrusion extending from the anode base. The cathode has a cathode base and at least one protrusion extending from the cathode base toward the anode base such that the at least one protrusion of the anode mates with the at least one protrusion of the cathode. In some embodiments, the at least one protrusion of the anode includes a cylindrical protrusion and the at least one protrusion of the cathode includes a plurality of cylindrical protrusions. The cylindrical protrusion of the anode is between two cylindrical protrusions of the plurality of cylindrical protrusions of the cathode. In some embodiments, the anode includes a plurality of cylindrical protrusions extending from the base, each protrusion of the plurality of cylindrical protrusions of the anode being between corresponding cylindrical protrusions of the plurality of cylindrical protrusions of the cathode. In some embodiments, the at least one protrusion of the cathode includes a plurality of concentric cylindrical protrusions. In some embodiments, the cathode includes a frame extending about an air chamber. In some embodiments, the battery cell includes a housing about the cathode and the anode and an outer protrusion of the at least one protrusion of the cathode is adjacent to the housing. In some embodiments, the housing is air permeable to permit air to flow therethrough to and from the cathode.

In some embodiments, a battery cell is provided including an anode, a cathode, and an electrolyte. The anode has an anode base and at least one protrusion extending from the anode base. The cathode has a cathode base and at least one protrusion extending from the cathode base toward the anode base such that the at least one protrusion of the anode mates with the at least one protrusion of the cathode. The electrolyte is between the anode and the cathode. In some embodiments, the at least one protrusion of the anode is spaced apart from the at least one protrusion of the cathode and the electrolyte is disposed in the space therebetween.

In some embodiments, a battery cell is provided including an anode, a cathode, and a hybrid solid-state electrolyte. The anode includes a magnesium anode body, for example, formed of magnesium (e.g., at least 99%, 99.99%, or 99.999% pure magnesium) or a magnesium alloy such as those discussed herein. As one example, the magnesium alloy of the anode body has a percent by weight ratio in a range of about 77.0-99.8% wt. magnesium, 0.1-8.0% wt. aluminum, 0.1-5.0% wt. zinc, 0-5.0% wt manganese, and 0-5.0% wt. iron The cathode includes a cathode body. The hybrid solid-state electrolyte is between the anode body and the cathode body. The hybrid solid-state electrolyte includes an anolyte layer, a catholyte layer, and an ion exchange membrane between the anolyte layer and the catholyte layer. The catholyte layer may be adjacent the cathode body and the anolyte layer may be adjacent the anode body. In some embodiments, the anolyte layer includes a base comprising a magnesium alginate saturated with magnesium chloride and sodium chloride anolyte. In some embodiments, the ion exchange membrane includes a polyvinylidene difluoride-sulfonated poly(ether ether ketone)-Polyvinylpyrrolidone ion exchange membrane. In some embodiments, the catholyte layer has a substrate (for example, nylon, polypropylene, PTFE, anodized aluminum foil or microfoil, aluminum foil or microfoil, alumina (aluminum oxide), cotton, nylon, polyesters, glass fibers, polyethylene, polypropylene, polyvinyl chloride films, and/or rubber) saturated with an aqueous sodium hydroxide.

In one aspect, a method of making a battery cell is provided. The method includes forming an anode body of magnesium, such as an anode body according to any of the embodiments described herein. Forming the anode body may include, for example, forming the anode body of a magnesium alloy having a percent by weight ratio in a range of about 77.0-99.8% wt. magnesium, 0.1-8.0% wt. aluminum, 0.1-5.0% wt. zinc, 0-5.0% wt manganese, and 0-5.0% wt. iron. The method includes forming a cathode body, such as a cathode body according to any of the embodiments described herein. The method includes positioning the anode body and the cathode body in a housing having at least a portion permeable to air and with an electrolyte between the anode and the cathode. In some embodiments, the method includes saturating a separator sheet with an electrolyte solution of the electrolyte and positioning the saturated separator sheet between the anode body and cathode body. In some embodiments, the method includes forming a solid state electrolyte and positioning the solid state electrolyte between the anode body and cathode body.

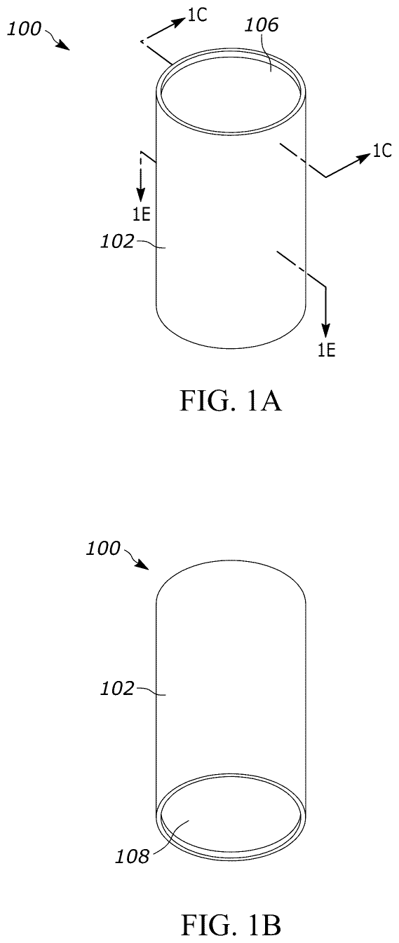

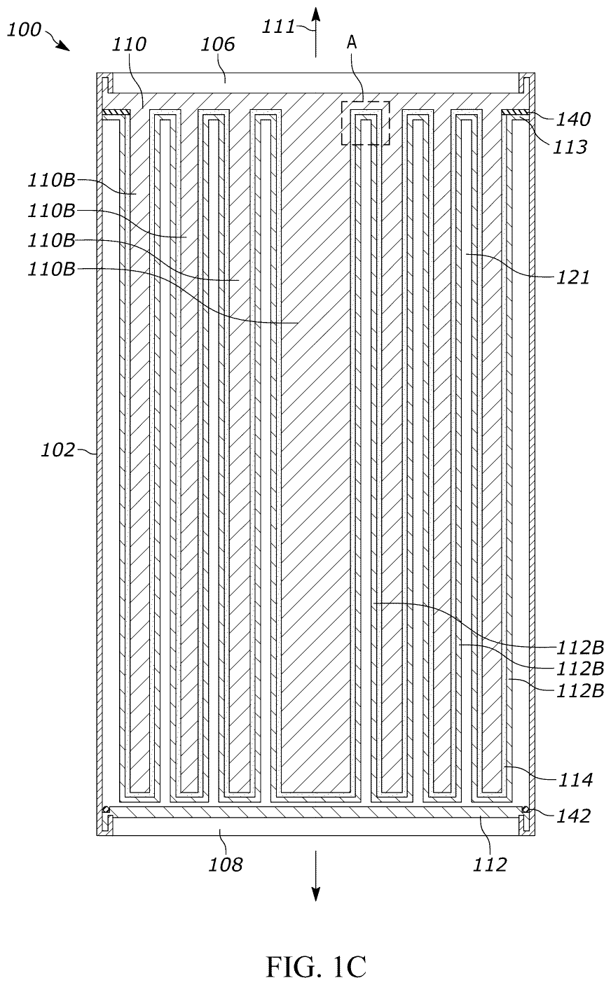

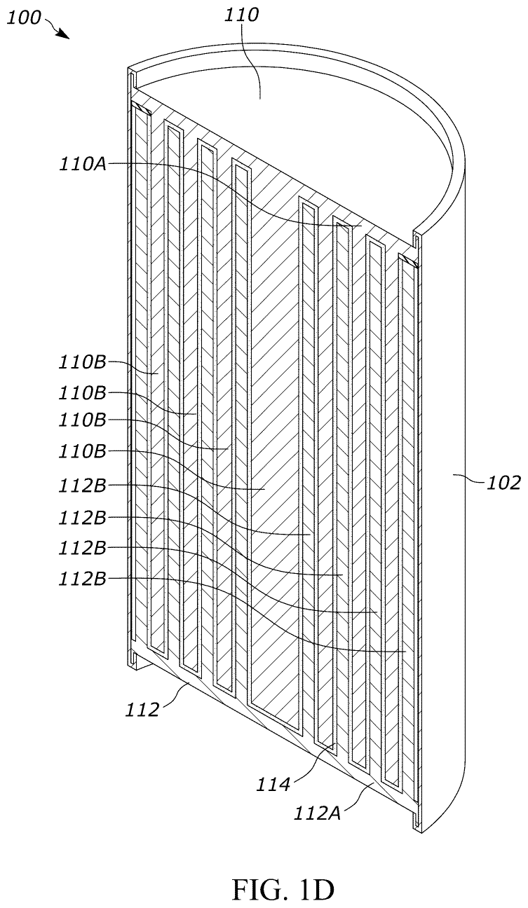

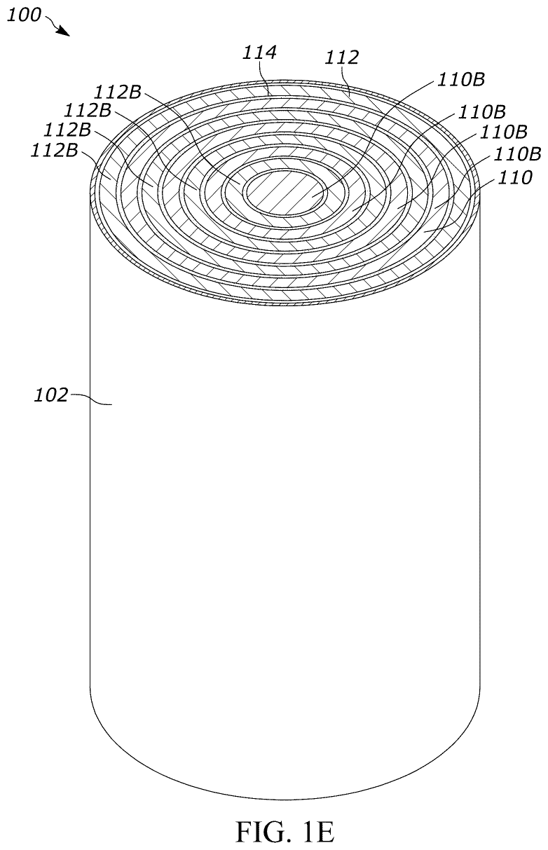

With respect to FIGS. 1A-1E, a magnesium battery cell 100 is provided. The battery cell 100 includes a housing 102 that contains an anode 110, a cathode 112, and an electrolyte 114. The housing 102 may include a structural casing. The structural casing of the housing 102 may be made of an electrically insulating and thermally conductive material, for example, a steel and/or anodized aluminum alloys 6061, 6063, and/or 1100. The structural casing of the housing 102 may have a mesh construction or include microscopic pores sized to permit oxygen flow therethrough while inhibiting liquids (e.g., water) from passing therethrough. Additionally or alternatively, the housing 102 may include one or more waterproofing or liquid barrier layers. The liquid barrier layer(s) may be disposed over the structural casing of the housing 102 such that the housing 102 permits air to flow therethrough while inhibiting liquid (e.g., the water or external contaminant) from entering or exiting the battery cell 100 through the housing 102. The liquid barrier layer(s) may be made of, for example, polytetrafluoroethylene (PTFE) and/or a 3D printed mesh that permits the flow of ions but inhibits the flow of water.

In the form shown, the housing 102 is cylindrical to provide a cylindrical format battery cell. The cylindrical format may have a length and/or diameter consistent with a standard cell configuration, for example, a standard cell configuration used for existing lithium-ion batteries (e.g., 18650 cells or 4680 cells). Sizing the battery cell 100 to have a size and shape consistent with existing batteries, e.g., lithium-ion batteries, may enable the battery cell 100 to be used in place of such batteries to enable a seamless transition to use of the battery cells 100 provided herein. The cylindrical shape of the battery cell 100 also permits several battery cells 100 to be packed efficiently in a battery case, while providing space between the battery cells 100 to permit heat generated by the battery cells 100 to dissipate from the battery cells 100. While the following discussion primarily relates to a battery cell having a cylindrical format, the battery cell 100 according to the teachings of this disclosure may have other forms. For example, the housing 102 may have other shapes to form battery having a coin, prismatic, or pouch format.

The battery cell 100 includes a positive terminal 106 and a negative terminal 108. The positive terminal 106 and negative terminal 108 may be electrically connected to a load to provide electrical power to the load. For example, current may flow from the positive terminal 106 through the load to the negative terminal 108 to provide electrical power to the load. The load may be any type of electrically powered device, for example, an electric car motor, a car motor, heavy machinery motors, an electric jet motor, a medical device, a home micro grid, and/or a light. The battery cell 100 may be charged by connecting the positive terminal 106 and negative terminal 108 to a battery charging circuit, to cause current to flow from the negative terminal 108 to the positive terminal 106.

With respect to FIGS. 1C-1E, cross-sectional views of the battery cell 100 are provided showing the anode 110, the cathode 112, and the electrolyte 114 between the anode 110 and the cathode 112. In the embodiment shown, the anode 110 includes a base 110A and protrusions 110B extending axially from the base 110A along axis 111. The protrusions 110B may be cylindrical protrusions, such as an annular wall and/or cylindrical post. For instance, in the form shown, the protrusions 110B include a central cylindrical protrusion or core and outer protrusions or walls extending about the central protrusion. The protrusions 110B are concentric (see FIG. 1E) and spaced radially from one another, forming gaps therebetween for receiving the electrolyte 114 and mating with portions of the cathode 112 as discussed below. In the form shown, the anode 110 has four protrusions 110B, a central core having an exterior surface and three annular walls extending circumferentially about the core, each having an interior and exterior surface. As discussed below, forming the anode 110 to include a plurality of protrusions 110B that extend from the base 110A increases the surface area of the anode 110, which may improve the efficiency of the battery cell 100 and/or the energy density of the battery cell 100. In other forms, the anode 110 may include a different number of protrusions 110B, for example, two, three, five, or more. The protrusions 110B may also take other shapes and configurations. For example, the protrusions 110B may include a plurality of posts that mate or overlap with protrusions 112B of the cathode 112 to increase the surface area between the anode 110 and the cathode 112.

The anode 110 may be formed of a chemically stable magnesium alloy that has the energy density characteristics of pure magnesium while allowing for reduction-oxidation (redox) reactions to occur. The anode 110 preferably also has high thermal conductivity and has high corrosion resistance. The anode may be formed with an alloy that is light weight and easily formable in a manufacturing process. The anode 110 may be formed of an alloy composed of a magnesium alloy having a percent by weight ratio in a range of about 77.0-99.8% wt. magnesium, 0.1-8.0% wt. aluminum, 0.1-5.0% wt. zinc, 0-5.0% wt manganese, and 0-5.0% wt. iron. In one example, the anode 110 is composed of about 92.0-97.9% wt. magnesium, 2.0-7.2% wt. aluminum, and 0.1-5.0% wt. zinc. As one example, the anode may be formed of magnesium AZ61 alloy having a percent by weight ratio of about 93% wt. magnesium, 6.0% wt. aluminum, and 1% wt. zinc. As another example, the anode is made from AZ31 having a percent by weight ratio of 96% wt. magnesium, 3% wt. aluminum, and 1% wt. zinc. As another example, the anode is made of MA8M06 magnesium alloy, having a percent by weight ratio of 97% wt. magnesium, 1.3% wt. manganese, 0.12% wt. zinc, 0.12% wt. aluminum, and 0.2% wt. iron. In some embodiments, the magnesium alloy of the anode 110 further comprises a percent by weight ratio of one or more of 0.1-2% wt. germanium, 0.1-5% wt. calcium, 0.1-3% wt. samarium, 0.1-5% wt. gallium, and 0.1-3% wt. indium. In one embodiment, the anode 110 is formed of a solid magnesium alloy. The anode 110 is thermally conductive to dissipate heat generated from electrochemical reactions.

In some embodiments, the anode 110 is formed of a pure magnesium rather than an alloy, for example, 99% magnesium, 99.99% magnesium, or 99.999% magnesium. To address issues with the chemical instability of a pure magnesium anode, the pure magnesium anode 110 may be ultra-fine grained which provides barriers to corrosion and corrosion-species propagation by the increase in concentration of grain boundaries over the anode surface, which helps to stabilize the surface microstructure of the anode 110. In other words, by using ultra-fine grained pure magnesium, there is a higher concentration of grain boundaries between the individual grains, and these grain boundaries are each a physical barrier to the propagation of corrosion and the propagation of corrosion species which aids in stabilizing the pure magnesium anode.

In one embodiment, the anode 110 is a foam (e.g., a metal foam such as a macro-foam, micro-foam, or nanofoam). A macro-foam has an average pore diameter on the order of millimeters or larger, a micro-foam has an average pore diameter on the order of micrometers, and a nanofoam has an average pore diameter on the order of nanometers or smaller. The anode 110 is formed of the magnesium alloy body with pores extending in the body. The foam structure increases the specific surface area of the anode 110 which allows for a greater reaction surface area because the electrolyte 114 is able to penetrate into the pores of the foam body and which permits more magnesium to react with the electrolyte 114 before the anode 110 is passivated. For instance, as the magnesium reacts with the electrolyte 114, a passivating or electrically insulating surface film forms at the interface of the electrolyte with the magnesium body which inhibits the magnesium under such film from reacting with the electrolyte 114 to generate electricity. Increasing the reaction surface area (e.g., with the foam structure) increases the amount of magnesium able to interact with the electrolyte 114. The increased reaction surface area also improves the discharge characteristics of the battery cell because the resulting passivating surface films at any particular location will be less dense or thinner due to the increased reaction surface area. As a result, the anode 110 is able to produce a more consistent output voltage during discharge, and may have an improved ability to dissolve the passivating surface films during discharge.

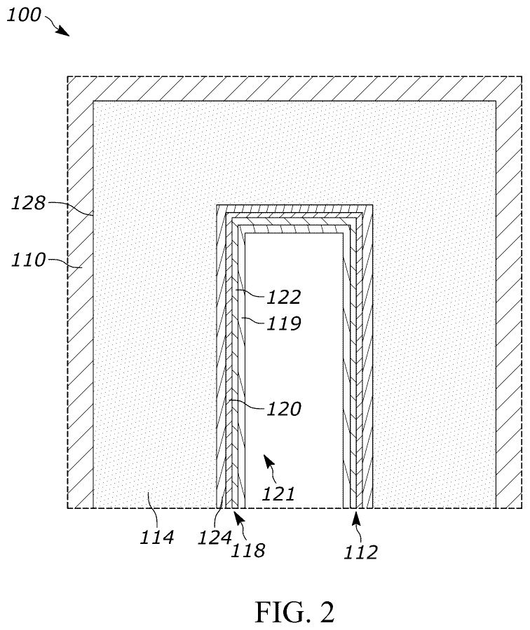

In the embodiment shown, the cathode 112 includes a base 112A and protrusions 112B extending axially from the base 112A along axis 111 toward the base 110A of the anode 110. The protrusions 112B may be cylindrical protrusions, such as an annular wall and/or cylindrical post. For instance, in the form shown, the protrusions 112B of the cathode 112 include a plurality of annular protrusions. The protrusions 112B may be cylindrical walls that are concentric (see FIG. 1E) and spaced radially from one another, forming gaps therebetween for receiving the electrolyte 114 and meshing or mating with the opposing protrusions 110B of the anode 110. For example, the diameter of the annular protrusions 112B of the cathode 112 are different than those of the protrusions 110B of the anode 110 such that the protrusions 110B of the anode 110 are received in the gaps between the protrusions 112B of the cathode 112 and vice versa. In such a configuration, the protrusions 110B, 112B of the anode 110 and the cathode 112 complement one another to mate together as shown in FIGS. 1C-1D. The outermost annular protrusion 112B of the cathode 112 may be outside of the outermost protrusion 110B of the anode 110 so that the cathode 112 extends along the housing 102 and is able to receive air through the housing 102. Having the cathode 112 extend along the housing 102 increases the surface area of the cathode 112 through which air may diffuse into the cathode 112 which provides for faster charging and discharging times. In the form shown, the cathode 112 has four annular protrusions 112B that extend circumferentially about the axis 111. Forming the cathode 112 to include a plurality of protrusions 112B that extend from the base 112A increases the surface area of the cathode 112, which may improve the efficiency and energy density of the battery cell 100. In other forms, the cathode 112 may include a different number of protrusions 112B, for example, two, three, five, or more to complement the protrusions 110B of the anode 110. In other forms, the cathode 112 includes the central core or post rather than the anode 110, and the protrusions of the anode 110 extend circumferentially about the central core of the cathode 112. With reference also to FIG. 2, a schematic diagram illustrating a detail view of the cross-section of portion A of FIG. 1C is provided. The base 112A and protrusions 112B of the cathode 112 are formed of shell or casing assembly 118 that forms a wall about an interior or gas chamber, such as oxygen chamber 121. In other words, the cathode 112 may be substantially hollow to form an oxygen chamber 121 for air to flow in the cathode 112 to provide oxygen to facilitate the chemical reactions of the battery cell 100. The oxygen chamber 121 extends in the base 112A and protrusions 112B of the cathode 112.

The casing assembly 118 includes a frame 119, a collecting layer 120, a liquid barrier 122, and a catalyst layer 124. The frame 119 of the cathode 112 may be formed of a chemically stable magnesium alloy that has the energy density characteristics of pure magnesium while allowing for reduction-oxidation (redox) reactions to occur. The frame 119 preferably also has high thermal conductivity and high corrosion resistance. The frame 119 may be formed with an alloy that is light weight and easily formable in a manufacturing process. The frame 119 may have an alloy composed of about 92.0-97.9% wt. magnesium, 2.0-7.2% wt. aluminum, and 0.1-5.0% wt. zinc. As one example, the cathode may be formed of magnesium AZ61 alloy having a percent by weight ratio of about 93% wt. magnesium, 6% wt. aluminum, and 1% zinc. As another example, the cathode is made from AZ31 having a percent by weight ratio of 96% wt. magnesium, 3% wt. aluminum, and 1% wt. zinc. As another example, the cathode is made of MA8M06 magnesium alloy, having a percent by weight ratio of 97% wt. magnesium, 1.3% wt. manganese, 0.12% wt. zinc, 0.12% wt. aluminum, and 0.2% wt. iron.

The collecting layer 120 may be a metal mesh layer that includes a plurality of openings extending therethrough to the oxygen chamber 121 to permit air to pass into and out of the oxygen chamber 121 of the casing assembly 118. For example, the collecting layer 120 may be porous, having microscopic pores to permit air to flow therethrough. The air in the oxygen chamber 121 is used to provide hydroxide (OH—) to the cathode 112 in the reduction-oxidation reactions with the electrolyte 114. The cathode 112 is thus an air cathode. In some forms, collecting layer 120 may be formed of a doped graphite or graphene mesh. The graphite or graphene may be doped with a doping agent to increase the electrical conductivity. For example, the graphite or graphene may be doped with nitrogen, fluorine, phosphorus, boron, sulfur, chlorine or other acid dopants or compound dopants as discussed below. The collecting layer 120 serves as a current collector, enhancing conductivity by efficiently conducting electrons to and from the electrolyte 114. Efficient conduction of electrons to the electrolyte 114 improves the performance of the battery cell 100 during charging and discharging. Additionally, the mesh structure increases the surface area available for electrochemical reactions which increases the surface area in contact with the electrolyte 114 which can increase the efficiency and capacity of the battery cell 100. In other forms, the collecting layer 120 may have other structures that increase the surface area for the electrochemical reactions such as a foam, 3D scaffold, or 3D mesh structure. In other forms, the collecting layer 120 is formed of nickel (e.g., pure nickel). The collecting layer 120 also is thermally conductive to dissipate heat generated from the electrochemical reactions.

The liquid barrier 122 inhibits liquids, such as water, from passing therethrough to retain the electrolyte 114 in the battery cell 100. The liquid barrier 122 may be a layer disposed on the frame 119 between the frame 119 and the collecting layer 120. The electrolyte 114 is thus able to contact the collecting layer 120 of the casing assembly 118 to facilitate the chemical reactions but the liquid barrier 122 inhibits the electrolyte 114 from passing therethrough to the frame 119 and/or into the oxygen chamber 121 of the cathode 112. The liquid barrier 122 permits ions (e.g., OH— ions) to pass through the liquid barrier 122 from the oxygen chamber 121 to the electrolyte 114 and vice versa when the battery cell 100 is being discharged or charged, as discussed below. As one example, the liquid barrier 122 may be formed of a layer of PTFE. As another example, the liquid barrier 122 is a 3D printed porous layer that inhibits the flow of water therethrough while allowing ions to pass therethrough. The liquid barrier 122 may not be disposed on portions of the frame 119 that do not face the electrolyte 114, for example, portions of the frame 119 facing the housing 102 and/or oxygen chamber 121.

The catalyst layer 124 is disposed over portions of the collecting layer 120 in contact with the electrolyte 114. For example, the catalyst layer 124 may be disposed on the opposite side of the collecting layer 120 of the liquid barrier 122. The catalyst layer 124 may be formed of phosphate, for example. The catalyst layer 124 promotes the electrochemical reactions of the battery cell 100 during charging or discharging cycles, which reduces the energy required to cause the electrochemical reactions to occur, making the battery cell 100 more efficient. The catalyst layer 124 may also improve the conductivity of the cathode 112 which allows electrons to move more freely and with less resistance which boosts performance of the battery cell 100. The catalyst layer 124 enhances durability and stability of the battery cell 100, prolonging the life of the battery cell 100. The catalyst layer may also suppress the Hydrogen Evolution Reaction (HER), which inhibits energy losses and further optimizes the performance of the battery cell 100.

The electrolyte 114 is between the anode 110 and the cathode 112. The electrolyte 114 may fill the space between the anode 110 and the cathode 112. For example, the electrolyte 114 is disposed between the opposing protrusions 110B, 112B of the anode 110 and cathode 112 (see FIG. 1C), for example, in the gaps between the opposing cylindrical or annular walls of the anode 110 and cathode 112. The electrolyte 114 may contact and extend between the outer surfaces 128 of the anode 110 and the catalyst layer 124/collecting layer 120 of the cathode casing assembly 118. The electrolyte 114 permits ions to flow between the anode 110 and the cathode 112 when charging or discharging the battery cell 100. As one example, the electrolyte 114 includes a solution of sodium chloride (NaCl) with graphene oxide dispersed in the NaCl solution. The solution of the electrolyte 114 may have a percent by weight ratio of 0.1-10% wt. NaCl, 0.1-5.0% wt. graphene oxide, and 85-99.8% wt. water. As one specific example, the solution of the electrolyte 114 may have a percent by weight ratio of 3.5% wt. NaCl, 1% wt. graphene oxide, and 95.5% water. The graphene oxide component of the electrolyte 114 reduces corrosion of the anode 110 (e.g., the AZ31 anode). The graphene oxide component also increases the conductivity of the electrolyte 114 which improves reaction kinetics when charging or discharging the battery cell 100 which improves recharging and discharging times. The graphene oxide component also may stabilize the connection between the cathode 112 and anode 110 to reduce the formation of dendrites on the cathode 112 and anode 110. As another example, the graphene oxide component of the electrolyte 114 solution is replaced with a doped graphene or doped graphite, for example, nitrogen doped graphene, nitrogen doped graphite, fluorine doped graphene, fluorine doped graphite, phosphorus doped graphene, phosphorus doped graphene, boron doped graphene, and/or boron doped graphite. Other doping agents may be used to dope the graphene or graphite as discussed below. The doped graphene/graphite may make up 0.1-5.0% wt. of the electrolyte solution.

The battery cell 100 may further include insulators, such as insulating rings 140, 142 to electrically insulate the anode 110 from the cathode 112. As shown in FIG. 1C, the insulating ring 140 is positioned between the terminal end 113 of the outermost protrusion 112B of the cathode 112 and the base 110A of the anode 110 to insulate the anode 110 from the cathode 112. The insulating ring 140 may also electrically insulate the anode 110 from the housing 102. The insulating ring 140 may further seal the electrolyte 114 in the battery cell 100 and inhibit the electrolyte 114 from reaching the housing 102. The insulating ring 140 may also form a fluid tight seal to inhibit fluid and debris from entering the battery cell 100 between the anode 110 and the housing 102. The insulating ring 140 may be made of alumina colloid and/or an elastomeric material, such as silicone and/or rubber. The insulating ring 140 may be a material that is coated on the anode 110, cathode 112, and/or the housing 102 that is electrically insulative. In some forms, the insulating ring 140 is a gasket or O-ring.

The insulating ring 142 is positioned between the cathode 112 and the housing 102 to electrically insulate the cathode 112 from the housing 102. The insulating ring 142 also forms a fluid tight seal to inhibit fluid and debris from entering the battery cell 100 between the cathode 112 and the housing 102. The insulating ring 142 may be made of alumina colloid and/or an elastomeric material, such as silicone and/or rubber. The insulating ring 142 may be a material that is coated on the anode 110, cathode 112, and/or the housing 102 that is electrically insulative. In some forms, the insulating ring 142 is a gasket or O-ring.

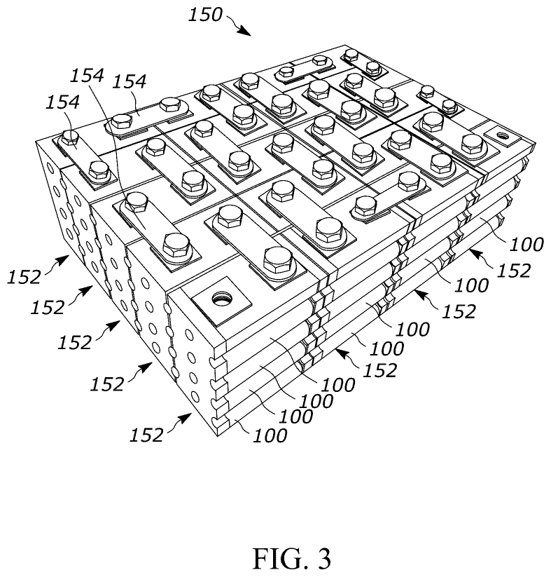

With reference to FIG. 3, the battery cell 100 may be part of an array of battery cells 104 connected together (e.g., in series and/or in parallel) to form a battery 150 to provide electrical power to the load 134. In the form shown, a plurality of battery cells 100 are connected in series to form a battery stack 152. The battery cells 100 may be connected together by load wires 130, 132 discussed below. The battery stacks 152 may be connected in series and/or parallel with the other battery stacks 152 to form a battery pack or the battery 150. In the form shown, the battery stacks 152 are connected in series with bus bars 154 that electrically connect terminals of two battery stacks 152 together. For example, the bus bar 154 extends from a positive terminal of one battery stack 152 to a negative terminal of another battery stack 152 to connect the battery stacks 152 in series. To connect the battery stacks 152 in parallel, a bus bar 154 may connect positive terminals of the battery stacks together and another bus bar may electrically connect negative terminals of the battery stacks 152 together. The bus bar 154 may be made of an aluminum graphene or copper graphene composite. For example, the bus bars 154 may have a composition of graphene in the range of about 0.1% wt. to about 5% wt. with the balance being aluminum or copper. These compositions provide a high conductivity and low resistance to make transfer of electrical power to the load more efficient.

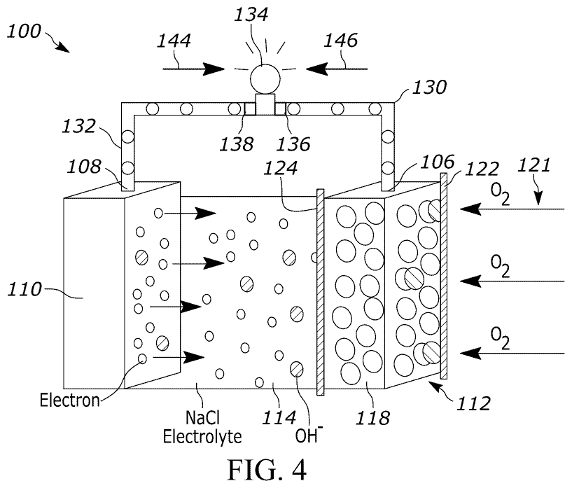

With respect to FIG. 4, the battery cell 100 may be used to provide electrical power to a load 134. The battery cell 100 (and/or battery) may be electrically connected to the load 134 via load wires 130, 132. The load wires 130, 132 may be formed, for example, of an aluminum graphene or copper graphene composite. For example, the load wires 130, 132 may have a composition of graphene in the range of about 0.1% wt. to about 5% wt. with the balance being aluminum or copper. These compositions provide a load wire of high conductivity and low resistance to make transfer of electrical power to the load more efficient. The load wires 130, 132 may be connected to a load 134 to provide electrical power of the battery cell 100 to the load 134. For instance, one load wire 130 may be used to electrically connect the positive terminal 106 (e.g., a terminal of the cathode 112) of the battery cell 100 to a positive terminal 136 of the load 134 and the other load wire 132 may be used to electrically connect the negative terminal 108 (e.g., a terminal of the anode 110) of the battery cell 100 to a negative terminal 138 of the load 134. The anode 110 and cathode 112 of the battery cell 100 may be indirectly connected to the load. For example, the load wires 130, 132 may connect the battery cell 100 in series or parallel with other battery cells 100 that together provide electrical power to the load as discussed above. The battery cell 100 may operate in a discharge mode to cause current to flow from the cathode 112 to the anode 110 through the load wires 130, 132 and the load 134. The battery charging circuitry may also include wires having an aluminum graphene or copper graphene composition to make transfer of electrical power to the battery cell 100 more efficient when operating in a charge mode.

The battery cell 100 operates in a discharge mode and a charge mode. In the discharge mode, chemical energy stored in the battery cell 100 is converted to electrical energy which is output to the load 134 that the positive terminal 106 and negative terminal 108 of the battery cell 100 are electrically connected to. In the charge mode, electrical power is applied to the battery cell 100 from a battery charging circuit connected to the positive terminal 106 and negative terminal 108 of the battery cell 100 which converts the supplied electrical energy to chemical energy stored in the battery cell 100.

In the discharge mode, the battery cell 100 is connected to the load 134 and converts chemical energy stored in the battery cell 100 to electrical energy to provide electrical power to the load 134. Specifically, the anode 110 goes through an oxidation reaction where the magnesium (Mg) atoms of the anode 110 lose two electrons and are oxidized to magnesium ions (Mg²⁺). The Mg²⁺ ions diffuse from the anode 110 and into the electrolyte 114. The free electrons may flow in direction 144 to the cathode 112 through the load 134, for example, via the load wires 130, 132. The cathode 112 goes through a reduction reaction where oxygen (O₂) from the air in the oxygen chamber 121 of the cathode 112 passes through the liquid barrier 122 and reacts with the water (H₂O) of the electrolyte 114 at the cathode 112. This reaction uses four free electrons received from the anode 110 through the load 134 and reduces the oxygen to hydroxide ions (OH⁻). The catalyst layer 124 accelerates the reduction reaction at the cathode 112 which increases the energy output and efficiency of the battery cell 100. The OH⁻ ions diffuse from the cathode 112 into the electrolyte 114. The Mg²⁺ ions from the anode 110 react with the OH⁻ ions from the cathode 112 in the electrolyte 114 to form magnesium hydroxide (Mg(OH)₂). As a result of these reactions, electrons flow from the anode 110 toward the cathode 112 through the load 134 providing electrical power to the load 134.

This process may continue until the chemical energy stored in the battery cell 100 has been depleted, the battery cell 100 is recharged (as discussed below), and/or the battery cell 100 is disconnected from the load 134 (e.g., for charging) such that electrons are not able to flow from the anode 110 to the cathode 112. The battery cell 100 may then be operated in the charge mode to recharge the battery cell 100 to permit the battery cell 100 to be used again.

In the charge mode, the process of the battery cell 100 is the reverse of the process in the discharge mode. A battery charging circuit applies a voltage across the positive terminal 106 and negative terminal 108 of the battery cell 100. The voltage applied by the battery charging circuit causes the magnesium hydroxide (Mg(OH)₂) in the electrolyte 114 to separate into magnesium ions (Mg²⁺) and hydroxide ions (OH⁻). The magnesium ions flow toward the anode 110 and the hydroxide ions flow toward the cathode 112 through the electrolyte 114. The hydroxide ions may pass through the pores of the collecting layer 120 and liquid barrier 122 to the oxygen chamber 121. The voltage applied to the battery cell 100 causes the hydroxide ions at the cathode 112 to lose electrons and be oxidized, forming oxygen (O₂) and water (H₂O). The voltage causes the electrons of the cathode 112 (e.g., those freed from the oxidation of the hydroxide ions) to flow to the anode 110 through the battery charging circuitry in direction 146. The catalyst layer 124 accelerates the oxidation of the hydroxide ions which increases the efficiency of the battery cell 100 by reducing energy loss. The voltage applied to the battery cell 100 causes the magnesium ions at the anode 110 to gain electrons provided by the battery charging circuit (e.g., from the cathode 112), reducing the magnesium ions back to metallic magnesium (Mg). This process may be continued until the battery charging circuit is no longer causing electrons to flow, indicating the battery cell 100 is fully charged, or until the battery charging circuit is disconnected from the battery cell 100.

In some forms, the housing 102 is air tight and does not permit air to pass therethrough into or out of the cathode 112. For example, the housing 102 may form a sealed (e.g., air tight) cavity about the cathode 112. The housing 102 may include a port, such as a one-way valve, through which air (e.g., oxygen) may be pumped into the cathode 112. For example, pressurized oxygen may be pumped into the oxygen chamber 121 of the cathode 112 and then the port closed to trap the oxygen in the cathode 112 for use in the chemical reactions of the battery cell 100 as discussed above. As oxygen escapes from the battery cell 100, the cathode 112 may need to be refilled with oxygen. The port may once again be used to pump air into the cathode 112 to ensure the battery cell 100 has sufficient oxygen for the chemical reactions of the discharge cycle. Having a sealed cavity where the cathode 112 is not exposed to the ambient air may be used in applications where the ambient does not include a sufficient supply of oxygen, for example, in space.

While the battery cell 100 has been described as being a cylindrical format battery cell 100, the teachings provided herein may be used to form magnesium-air batteries of other formats, for example, pouch or prismatic. In the pouch format, the anode 110 and cathode 112 may be plates that extend generally parallel to one another.

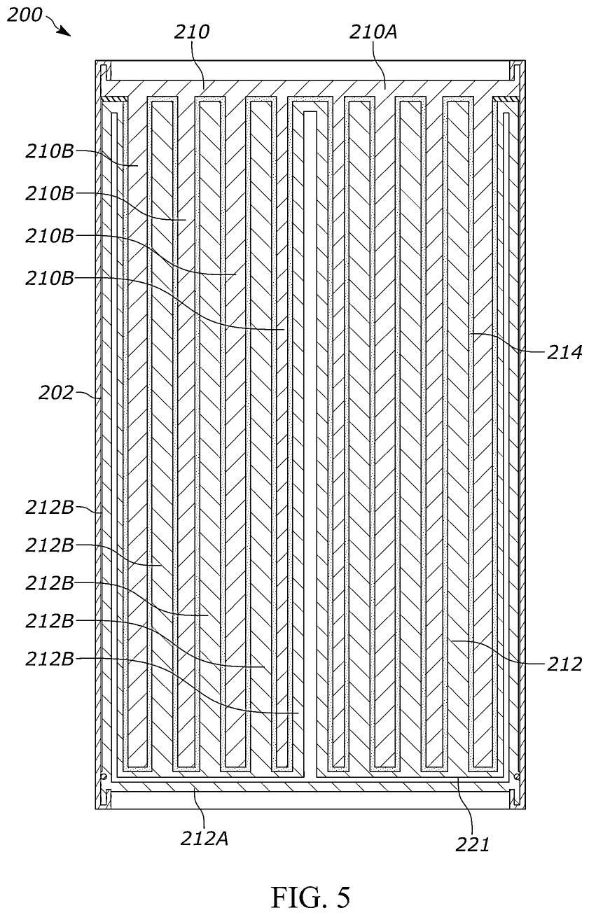

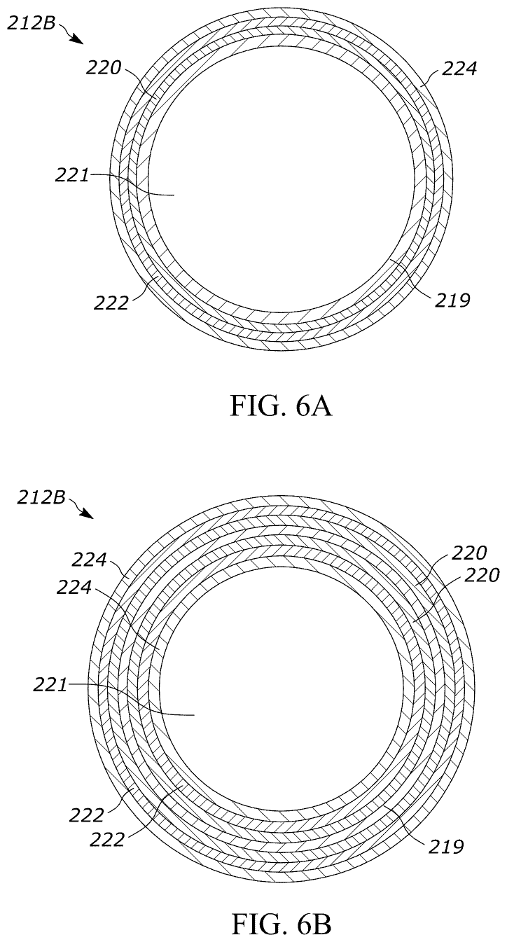

With respect to FIG. 5-6B, a battery cell 200 is provided according to another embodiment. The battery cell 200 is similar in many respects to the embodiments discussed above such that the differences are highlighted. The battery cell 200 includes an anode 210 and a cathode 212. The anode 210 has a base 210A and protrusions 210B that extend toward a base 212A of the cathode 212. The cathode 212 has the base 212A and protrusions 212B that extend toward the base 210A of the anode 210. The protrusions 210B of the anode 210 mesh or mate with the protrusions 212B of the cathode 212. In the embodiment shown, the cathode 212 has a central protrusion 212B or core that the protrusions 210B, 212B of the anode 110 and cathode 212 extend about. The cathode 212 has an oxygen chamber 221. In this embodiment, the oxygen chamber extends in only some of the protrusions 212B of the cathode 212. For instance, in the form shown, oxygen chamber 221 extends in the central protrusion 212B, the base 212A, and the outermost protrusion 212B of the cathode 212 along the housing 202. Oxygen is thus able to diffuse into the cathode 212 through the housing 202 of the battery cell 200 and flow to the innermost protrusion 212B or core of the cathode 212 to provide oxygen for the chemical reactions.

While the embodiment shown shows the oxygen chamber 221 extending in the outermost and innermost protrusions 212B, the oxygen chamber 221 may extend in any number or combination of the protrusions 212B to provide oxygen at the interface of the cathode 212 with the electrolyte 214 for the chemical reactions. Which protrusions 212B and the number of protrusions 212B in which the oxygen chamber 221 extends may be selected based on the application to provide a sufficient supply of oxygen at the cathode 212. In some forms, the oxygen chamber 221 extends annularly in the protrusions 212B. In some forms, the oxygen chamber 221 extends axially in the protrusions toward the terminal ends at discrete points about the circumference of the protrusion 212B. The oxygen chamber 221 may also be formed as a web or mesh that weaves through one or more of the protrusions 212B.

With respect to FIG. 6A, a cross-section diagram showing the layers of the innermost, central protrusion 212B of the cathode 212 is provided. The central protrusion 212B includes the magnesium alloy frame 219 (e.g., formed of AZ31) defining the oxygen chamber 221 therein. A liquid barrier layer 222, a collecting layer 220, and a catalyst layer 224 are outward the frame 219 to contact the electrolyte 214 as discussed above.

With respect to FIG. 6B, a cross-section diagram is provided that shows the layers of the protrusions 212B of the cathode 212 that do not include the oxygen chamber 221. The protrusion 212B includes the magnesium alloy frame 219. A liquid barrier layer 222, a collecting layer 220, and a catalyst layer 224 as discussed above are disposed on both the inward and outward side of the frame 219 to contact the electrolyte 214. Both the inward and outward layers may be one continuous layer that extends about the terminal end of the protrusion 212B.

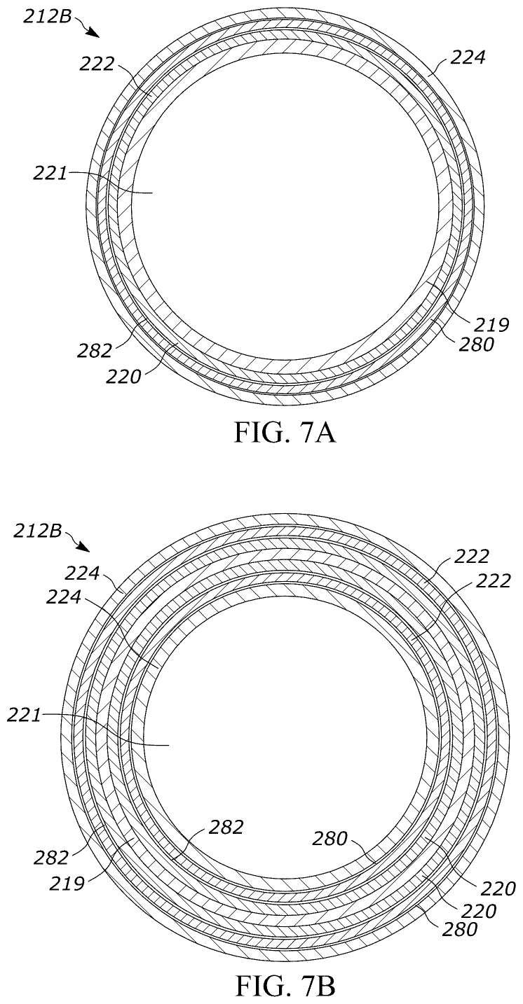

With respect to FIGS. 7A-7B, in some forms, there are gaps between the layers of the cathode 212. These gaps may provide space to store oxygen that is used in or output from the chemical reactions of the battery cell 200. Providing such gaps in the layers permits oxygen to be distributed along the interface of the cathode 212 with the electrolyte, even where the oxygen chamber 221 does not extend into a protrusion 212B of the cathode 212. For example, there may be one or more gaps 280 between the catalyst layer 224 and the collecting layer 220. The gap 280 need not entirely space the catalyst layer 224 from the collecting layer 220 but may provide one or more pockets therebetween for collecting oxygen. Additionally, or alternatively, there may be one or more gaps 282 between the collecting layer 220 and the liquid barrier layer 222. The gap 282 need not entirely space the collecting layer 220 from the liquid barrier layer 222 but may provide one or more pockets therebetween for collecting oxygen.

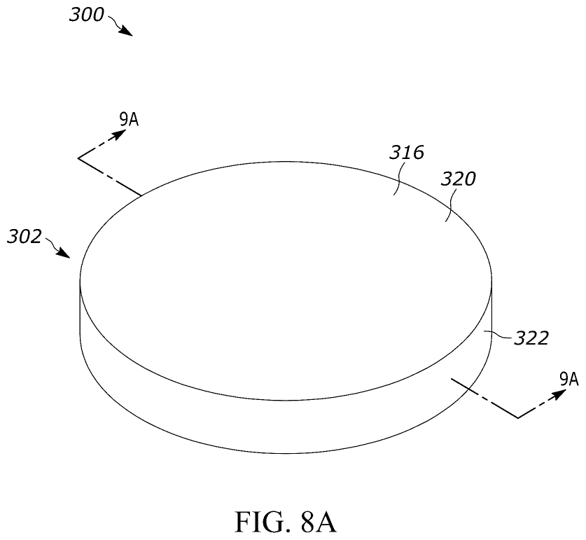

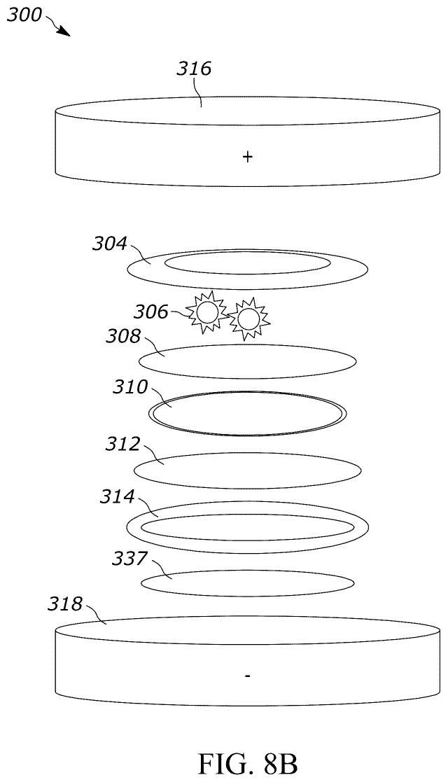

With respect to FIGS. 8A-9B and 12, a magnesium battery cell 300 is provided according to another embodiment having a coin cell battery format. The battery cell 300 is similar in many respects to the embodiments discussed above such that the differences will primarily be discussed. In particular, the electrochemical reactions and operation of the magnesium battery cell 300 are similar to those discussed above and will not be repeated for conciseness and clarity. The battery cell 300 has a case 302 that houses a cathode assembly 304, an electrolyte 306, a separator 308, an anode 310, a spacer 312, and a biasing member such as a spring 314.

The case 302 may be generally cylindrical to provide a coin cell format. The case 302 may have a height and/or diameter consistent with a standard coin cell configuration, for example, a standard cell configuration used for existing lithium-ion batteries (e.g., CR2032, CR2045, CR2025, CR2016, CR1620, and CR1216 cells). Sizing the battery cell 300 to have a size and shape consistent with existing batteries, e.g., lithium-ion batteries, may enable the battery cell 300 to be used in place of such batteries to enable a seamless transition to use of the battery cells 300 provided herein.

The case 302 includes a first case body 316 and a second case body 318. The first case body 316 and second case body 318 may be formed of a solid sheet metal, for example, 304, or 316, or 17-4 precipitation hardening (PH) stainless steels clad with aluminum, uncoated 304, 316, or 17-4 PH stainless steel alloys, anodized 6061, 6063, or 3003 aluminum alloys. The first case body 316 is in electrical contact with the cathode assembly 304 of the battery cell 300 and forms the positive terminal of the battery cell 300. The second case body 318 is in electrical contact with the anode 310 and forms the negative terminal of the battery cell 300. The battery cell 300 may be used to provide electrical power to a load by electrically connecting a positive terminal of the load to the first case body 316 (e.g., with a conductor) and electrically connecting a negative terminal of the load to the second case body 318 (e.g., with a conductor). The battery cells 300 may also be connected in an array of battery cells 300 (e.g., in series or in parallel) to provide electrical power to a load as discussed above.

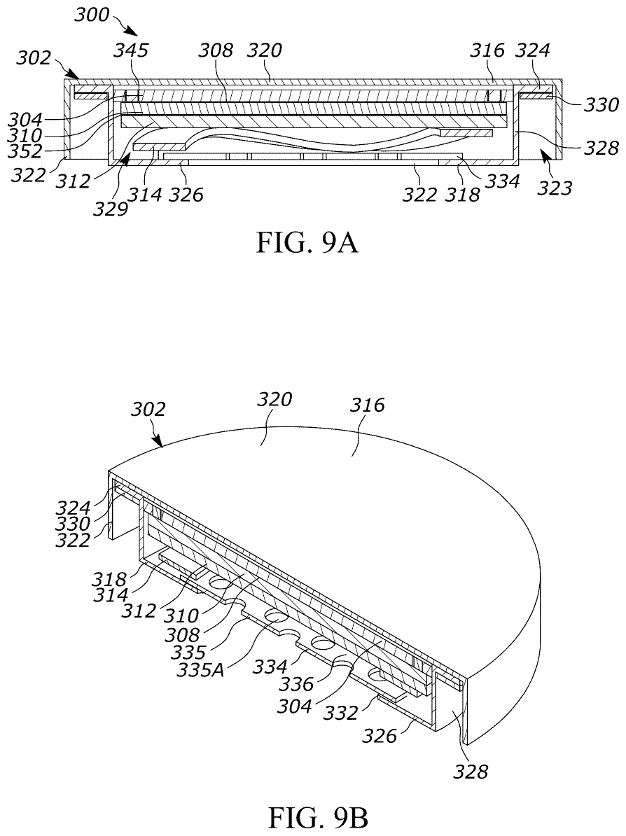

Referring to FIGS. 9A and 9B, the first case body 316 includes an end portion such as base 320 and a sidewall 322 extending from the base 320. The base 320 and sidewall 322 may form a recess 323 to receive a portion of the second case body 318 and internal components of the battery cell 300. The base 320 may be circular and the sidewall 322 may be annular. The sidewall 322 has an internal dimension, such as a diameter, sized to receive the second case body 318 therein. For example, the internal diameter of the sidewall 322 may be larger than the outer diameter of the second case body 318.

The second case body 318 has an end portion such as a base 326 and a sidewall 328 extending from the base 326 to a flange 324. The base 326 and sidewall 328 may form a recess 329 to receive and house internal components of the battery cell 300. The first case body 316 and second case body 318 thus cooperate to enclose the internal components of the battery cell 300 in an interior 336 of the case 302. The base 326 may be circular and the sidewall 328 may be annular. The sidewall 328 has an internal dimension, such as a diameter, sized to receive the cathode assembly 304, the separator 308, the anode 310, the spacer 312, and the spring 314 therein. When assembled, the flange 324 and sidewall 328 of the second case body 318 may extend into the recess 323 of the first case body 316 until the flange 324 of the second case body 318 is adjacent the base 320 of the first case body 316. An insulator may be disposed between the flange 324 of the second case body 318 and the base 320 of the first case body 316 to inhibit electrical flow therebetween. For example, an insulating coating (e.g., alumina) may be disposed on the flange 324 and/or portion of the base 320 that contacts the flange. As another example, an insulator (e.g., a rubber) may be positioned between the flange 324 and the base 320. The sidewall 322 may be crimped over the flange 324 to secure the first case body 316 to the second case body 318. The sidewall 322 may be crimped over a seal 330 to form a fluid tight connection therebetween to inhibit electrolyte from leaking from the battery case 302 and inhibit liquid and debris from entering the battery case 302. The seal 330 may also be an insulator to inhibit electrical flow between the first case body 316 and second case body 318.

The second case body 318 includes an air interface 331 through which air may flow through the case 302 into and out of the interior 336 of the battery cell 300. In this embodiment, the air interface 331 is in the base 326 of the second case body 318. The base 326 of the second case body 318 includes an opening 332 to permit air to flow into and out of the battery cell 300. The battery cell 300 includes a liquid barrier 334 extending across the opening 332 of the second case body 318. The liquid barrier 334 includes a mesh support 335 including a plurality of openings 335A and a liquid barrier layer 337 (see FIG. 8B) extending over the mesh support 335 to permit air passage through the air interface 331 while inhibiting liquid passage therethrough. The mesh support 335 may be a mesh insert or material including microscopic pores sized to permit oxygen flow therethrough while inhibiting liquids (e.g., water) from passing therethrough. The liquid barrier 334 may be disposed over the opening 332 of the second case body 318 such that the case 302 permits air to flow therethrough into the interior 336 of the case 302 while inhibiting liquid (e.g., electrolyte or external contaminant) from entering or exiting the battery cell 300 through the case 302. The liquid barrier 334 may be made of, for example, PTFE, an alumina (aluminum oxide) mesh, stainless steel mesh (304, 316, 17-4 PH alloys), doped graphene mesh (e.g., doped with nitrogen, fluorine, phosphorus, and/or boron) and/or a 3D printed mesh that permits the flow of air but inhibits the flow of water.

The battery cell 300 includes the seal 330 such as an O-ring or gasket on the flange 324 of the first case body 316. As mentioned above, the sidewall 322 of the first case body 316 is crimped over the seal 330 such that the seal 330 forms a fluid tight seal along the crimp joint of the first case body 316 and second case body 318. The seal 330 inhibits the electrolyte in the battery case 302 from leaking from the battery cell 300 and inhibits external contaminants (e.g., fluid and debris) from entering the battery case 302 along the crimp joint. The seal 330 also electrically insulates the first case body 316 and second case body 318. The seal 330 may be thermally conductive and facilitate heat transfer out of the batter cell 300. The seal 330 may be formed, for example, of rubber, polypropylene, nylon, alumina (aluminum oxide), and/or anodized aluminum 6061/6063.

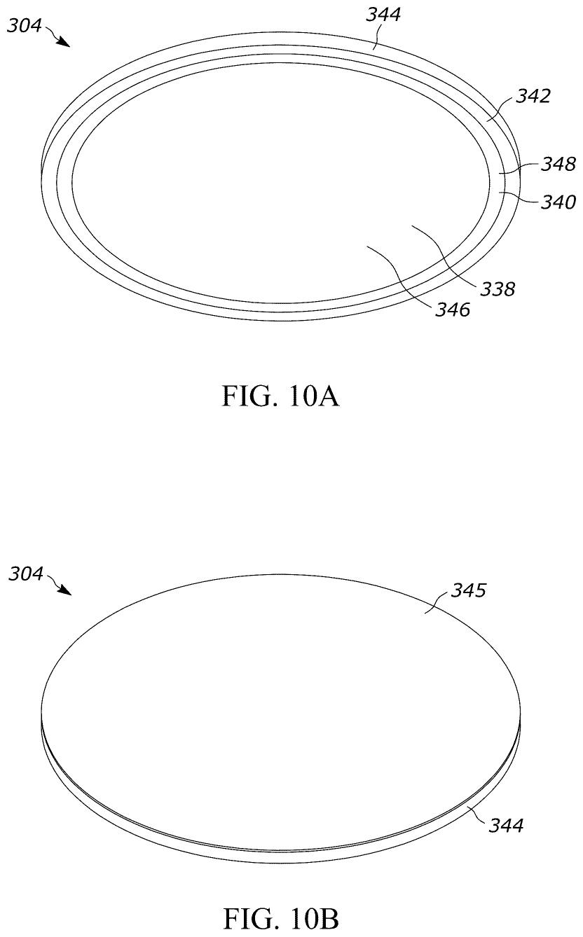

With reference also to FIGS. 10A-10B, the cathode assembly 304 includes a cathode 338, a liquid barrier 340, a collector 342, a catalyst layer 344, and a current collector 345. While having a different structure, the cathode assembly 304 is similar in many respects to the cathode casing assembly 118 discussed above. The cathode 338 includes a cathode body 346 that may be formed of a material similar to that discussed above with respect to the cathode frame 119 of the battery cell 100. As one example, the cathode body 346 is made of AZ31. The cathode body 346 has a flat cylindrical shape (e.g., a disc or plate shape).

The liquid barrier 340 extends about the cathode 338 to inhibit liquid from flowing between the cathode 338 and the remainder of the interior 336 of the case 302 in which the electrolyte 306 is disposed. The liquid barrier 340 may have a ring-shaped body 348 that encompasses the cathode 338. The liquid barrier 340 may be sandwiched between the base 320 of the first case body 316 and the separator 308. The liquid barrier 340 may be laminated to the cathode body 346. The spring 314 may apply a biasing force that presses the separator 308 against the liquid barrier 340 and the opposite side of the liquid barrier 340 against the current collector 345 (which is pressed against the base 320 of the first case body 316) to form fluid tight connections therebetween. The liquid barrier 340 may be formed of a material similar to that discussed above with respect to the liquid barrier 122. For example, the liquid barrier 340 is made of PTFE, alumina (aluminum oxide) mesh, stainless steel mesh (304, 316, or 17-4 PH alloys), and/or doped graphene mesh (e.g., doped with nitrogen, fluorine, phosphorus, and/or boron).

The collector 342 extends about the liquid barrier 340. The collector 342 functions similar to the collecting layer 120 of the battery cell 100 discussed above. The collector 342 may have a ring shape and extend about the periphery of the cathode assembly 304. The collector 342 may be laminated to the liquid barrier 340. As in the previous embodiments, the collector 342 may be porous, having microscopic pores to permit air to flow therethrough. For example, the collector 342 may be a metal mesh, foam, 3D scaffolds, or 3D meshes that includes a plurality of openings extending therethrough to permit air to pass to and from the cathode assembly 304. In some forms, collector 342 may be formed of an aluminum-graphene alloy, an aluminum-doped graphene alloy, a copper-graphene alloy, and a copper-doped graphene alloy, a doped graphite and/or doped-graphene. The doping agents may be, as examples, nitrogen, fluorine, phosphorus, and/or boron. The collector 342 may have a mesh structure. The collector 342 serves as a current collector, enhancing conductivity by efficiently conducting electrons to and from the electrolyte 306.

The catalyst layer 344 is disposed over portions of the collector 342 in contact with the electrolyte 306. For example, the catalyst layer 344 may be disposed on the side of the collector 342 opposite the liquid barrier 340 such as on the outward edge or peripheral edge of the collector 342. The catalyst layer 344 may be a coating or film applied to the collector 342. The catalyst layer 344 is similar in many respects to the catalyst layer 124 discussed above. As one example, the catalyst layer 344 is formed of phosphate, for example, zinc-phosphate. As one example, the catalyst layer 344 is formed of manganese oxide. In some forms, the catalyst layer 344 is comprised of multiple catalyst layers of differing electrocatalyst materials, for example, a manganese oxide layer and a zinc phosphate layer.

The cathode assembly 304 may include the current collector 345 which is disposed on the side of the cathode 338 facing the base 320 of the first case body 316. The current collector 345 may contact the first case body 316 (e.g., the base 320) to conduct electrical flow between the cathode 338 and the first case body 316. The spring 314 urges the current collector 345 against the base 320 of the first case body 316 to ensure the current collector 345 engages the base 320 to form electrical contact therebetween to permit electron movement between the cathode body 346 and the base 320. The current collector 345 may be formed of, for example, pure aluminum, pure copper, pure zinc, graphene, a zinc graphene alloy, a doped graphene or doped graphite zinc alloy, a graphene aluminum alloy, and/or a doped-graphene or doped graphite aluminum alloy. The doped graphene or doped graphite may be doped with nitrogen, fluorine, and/or boron. Where the current collector 345 is formed of a metal, the current collector 345 may be a foil or microfoil. A foil has a thickness on the order of millimeters. A microfoil has a thickness on the order of micrometers. Where the current collector 345 is formed of a non-metal, the current collector 345 may be a film disposed on the cathode 338.

In some embodiments, the cathode body 346 includes a porous substrate such as a porous carbonaceous substrate. As one example, the porous substrate is a carbon paper. The porous substrate includes pores such as openings and passageways in the cathode body 346 which permits air to move in the cathode 338. The catalyst layer 344, liquid barrier 340, and/or collector 342 may be layer(s) dispersed over the porous cathode body 346, for example to form one or more layers coating the porous cathode body 346. For example, the material of the catalyst layer 344 (e.g., manganese oxide) and/or collector 342 (e.g., doped graphene powder/nanofoam) may be mixed with a binder and disposed over, such as cast on to, the porous substrate of the cathode body 346, e.g., to coat the porous cathode body 346. The catalyst layer 344, liquid barrier 340, and/or collector 342 may thus be combined, for example, to form a single, homogenous layer comprised of the catalyst, liquid barrier, and/or collecting layer materials.

As one example, the cathode body 346 has a percent by weight ratio in a range of about 0-90% wt. doped graphene and/or manganese oxide, 0-10% wt. carbon substrate, and 0-10% binding agent. The binding agent may include for example, polyvinylidene fluoride and/or polyvinylidene difluoride. As another example, the cathode body 346 has a percent by weight ratio in a range of about 0-90% wt. graphene (doped or non-doped) and/or a crushed graphene nanofoam, 0-10% wt. carbon substrate, and 0-10% wt. binding agent. The binding agent may include for example, polyvinylidene fluoride and/or polyvinylidene difluoride. As an example, the cathode body may include about 45% wt. N-doped graphene nanopowder, 45% wt. manganese oxide powder, 5% wt. carbon paper, and 5% wt. polyvinylidene fluoride and/or polyvinylidene difluoride binder.

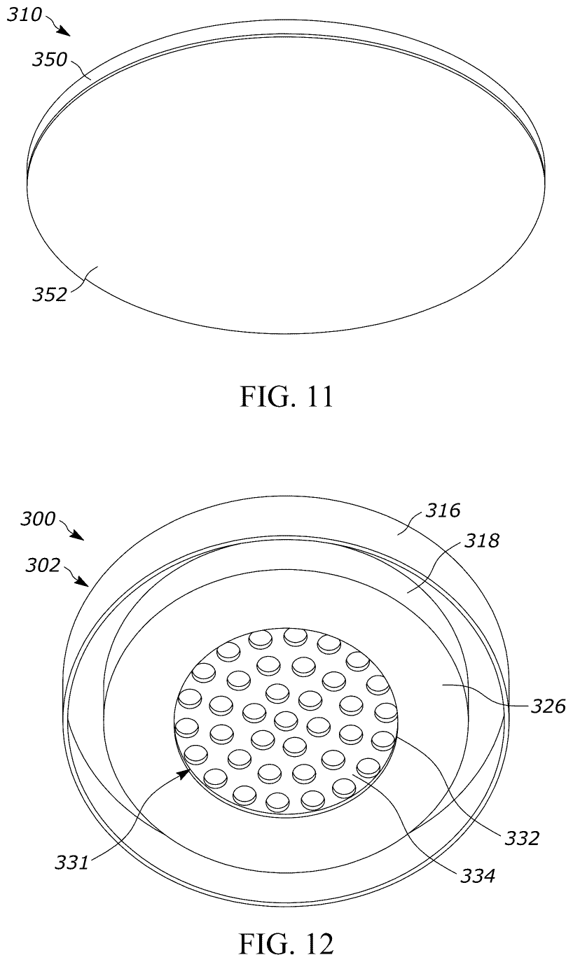

With reference to FIG. 11, the anode 310 includes an anode body 350 and may include a current collector 352. The anode body 350 has a flat cylindrical shape (e.g., a disc or plate shape). The anode body 350 may be formed of a material similar to that discussed above with respect to the anode 210 of the battery cell 100. As one example, the anode body 350 may be formed of AZ31. The current collector 352 is disposed on the side of the anode 310 facing the spacer 312. The current collector 352 contacts the spacer 312 to conduct electrical flow between the anode body 350 and the spacer 312. The spring 314 urges the spacer 312 against the current collector 352 to ensure the current collector 352 engages the spacer 312 to form electrical contact therebetween to permit electron movement between the anode body 350 and the spacer 312. The current collector 352 may be a foil or microfoil layer formed, for example, of pure aluminum, pure copper, pure zinc, graphene, a zinc graphene alloy, a doped graphene or doped graphite zinc alloy, a graphene aluminum alloy and/or a doped-graphene or doped graphite aluminum alloy. The doped graphene or doped graphite may be doped with nitrogen, fluorine, and/or boron.

With reference again to FIGS. 8B-9B, the separator 308 is positioned between the anode 310 and the cathode assembly 304. The separator 308 may be a permeable membrane that is able to absorb the electrolyte 306 to facilitate electron transfer through the electrolyte 306 between the cathode assembly 304 and the anode 310. The separator 308 has a first side that contacts the cathode body 346 and an opposite second side that contacts the anode body 350. The separator 308 may be formed, for example, of nylon, polypropylene, PTFE, anodized aluminum foil or microfoil, aluminum foil or microfoil, alumina (aluminum oxide), cotton, nylon, polyesters, glass fibers, polyethylene, polypropylene, polyvinyl chloride films, and/or rubber.

In some embodiments, the separator 308 is a solid separator which may absorb, such as be saturated (fully or partially) with, the electrolyte 306. The separator 308 may include an aerogel or a hydrogel. As examples, the separator 308 may include a graphene aerogel, a graphene hydrogel, a doped graphene aerogel, a doped graphene hydrogel, and/or agar gel. As on example, the separator 308 includes a graphene aerogel or graphene hydrogel doped with carbon nanotubes. As one example, the separator 308 has a percent by weight ratio in a range of about 0.1-10% wt. agar, 0.1-20% sodium chloride, 0.1-60% wt. ionic salt with a complexing agent, 0-10% wt. doped graphene powder, and the balance water. For example, the ionic salt may include a central metal ion and complexing agent. As examples, the central metal ion includes one or more of lithium, magnesium, potassium, sodium and zinc and the complexing agent includes one or more of nitrate, ammonium, sulfate, phosphate, acetate, chloride, and hydrogen. As examples, the ionic salts with a complexing agent include ionic magnesium salts with a complexing agent such as magnesium sulfate, magnesium chloride, magnesium phosphate, magnesium nitrate, and/or magnesium acetate, and ionic lithium salts with a complexing agent such as lithium bis(trifluoromethanesulfonyl)imide, lithium hexafluorophosphate, lithium nitrate, lithium bis(fluorosulfonyl)imide, and/or lithium tetrafluoroborate. These salts may be dispersed in the material of the separator 308 when produced. As one example, the separator 308 has a percent by weight ratio in a range of about 0.1-10% wt. agar, 0.1-20% sodium chloride, 20-60% wt. ionic magnesium salt with a complexing agent, 0-10% wt. doped graphene powder, and the balance water. As one example, the separator 308 has a percent by weight ratio in a range of about 0.1-10% wt. agar, 0.1-20% sodium chloride, 20-60% wt. ionic lithium salt with a complexing agent, 0-10% wt. doped graphene powder, and the balance water. As one example, the separator 308 has a percent by weight ratio in a range of about 0.1-10% wt. agar, 0.1-20% sodium chloride, 5-25% wt. ionic lithium salt with a complexing agent, 15-35% wt. ionic magnesium salt with a complexing agent 0-10% wt. doped graphene powder, and the balance water.

The electrolyte 306 may be an aqueous electrolyte 306 saturating the separator 308. The electrolyte 306 may include ionic salt(s) with a complexing agent in water, such as those described above with respect to the separator 308. As one example, the electrolyte 306 includes a solution having a percent by weight ratio of about 0.1-20% wt. sodium chloride, 0.1-70% wt. ionic salt with a complexing agent, and 10-99.8% wt. water. As one example, the electrolyte has a percent by weight ratio of about 0.1% wt.-20% wt. sodium chloride, 30-70% wt. ionic magnesium salts with a complexing agent, and 10-69.9% wt. water. The ionic magnesium salts with a complexing agent may include, for example, those listed above with respect to the separator 308. As one example, the electrolyte has a percent by weight ratio of about 0.1-20% wt. sodium chloride, and 20-70% wt. ionic lithium salts with a complexing agent, and 10-79.9% wt. water. The ionic lithium salts with a complexing agent may include, for example those listed above with respect to the separator 308. As one example, the electrolyte has a percent by weight ratio of about 0-10% wt. sodium chloride, 20-50% wt. ionic magnesium salt, 5-30% wt. lithium salt, and 10-75% wt. water. Inclusion of such ionic salts in the electrolyte 306 and/or separator 308 creates a highly hygroscopic, chemically stable additive, which aids to retain water in the electrolyte 306 and/or separator 308.

The spacer 312 contacts the side of the anode 310 having the current collector 352. The spacer 312 may include a disc shaped body against which the spring 314 presses to urge the spacer 312 against the anode 310. The spacer 312 fills the space between wave spring 314 and the anode 310. The spacer 312 is electrically conductive and contacts the current collector 352 of the anode to conduct electrical flow between the anode 310 and the second case body 318 through the spring 314. The spacer 312 also provides a structure the spring 314 pushes against so that the spring 314 does not directly contact the current collector 352 of the anode 310, which may cause tears in or otherwise damage the foil/microfoil layer of the current collector 352. The spacer 312, having a large surface area in contact with the anode 310, distributes the force applied by the spring 314 uniformly to the anode 310. The spacer 312 may be formed of a 304 or 316 stainless steel alloy. The battery cell 300 may also include a cathode spacer, similar to spacer 312, between the cathode assembly 304 and the base 320 of the first case body. The cathode spacer similarly conducts electrical flow between the cathode assembly 304 (e.g., the cathode 338) and the first case body 316.

The spring 314 extends between the base 326 of the second case body 318 and the spacer 312. The spring 314 applies a biasing force to the spacer 312 to urge the spacer 312 toward the base 320 of the first case body 316. The spring 314 thus ensures the spacer 312, anode 310, separator 308, cathode assembly 304, and base 320 of the first case body 316 are in contact with one another. As one example, the spring 314 may be a Belleville washer or wave spring. The spring 314 may be formed of a conductive material to electrically connect the anode body 350 to the second case body 318. For example, the spring 314 may be formed of a 304 or 316 stainless steel alloy.

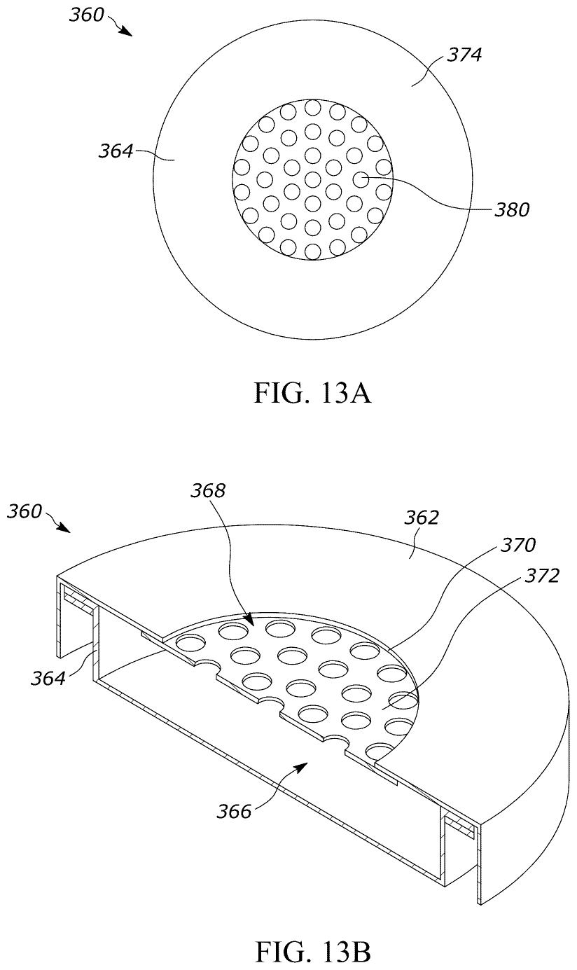

With respect to FIGS. 13A-13B, a battery case 360 is shown according to another embodiment for use with a magnesium battery cell, e.g., such as magnesium battery cell 300. The battery case 360 is similar in many respects to the case 302 such that the differences are highlighted. The battery case 360 includes a first case body 362 that cooperates with a second case body 364 to enclose an interior 366 to house the internal components of the battery cell. In the battery case 360, the first case body 362 includes an air interface 368 rather than the second case body 364. The first case body 362 includes an opening 370 over which a liquid barrier 372, similar to the liquid barrier 340 discussed above, is disposed to form the air interface 368. As one example, the opening 370 may have a diameter in the range of about 10 mm to about 16 mm. The air interface 368 permits air to flow therethrough but inhibits liquids from passing therethrough. The first case body 362 may contact the cathode assembly 304. The air interface 368 may be adjacent the cathode assembly 304 to permit air to flow to and from the battery cell 300 from the cathode side of the battery cell 300.

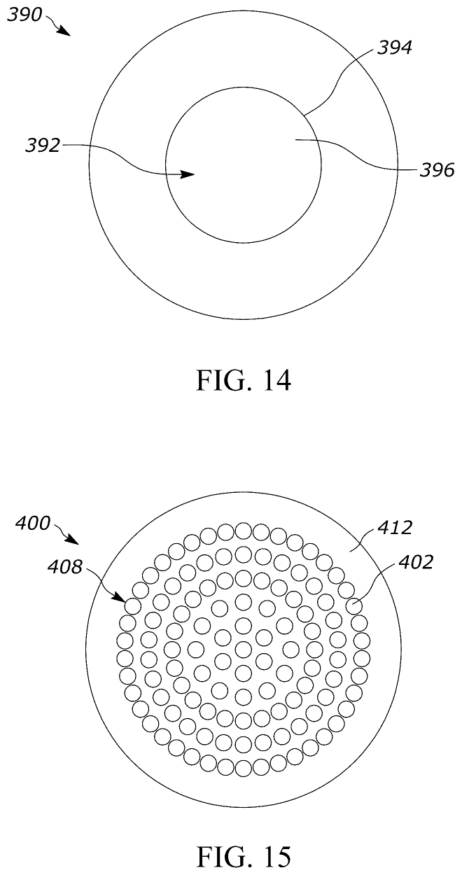

With respect to FIG. 14, a battery case 390 is shown according to another embodiment for use with a magnesium battery cell, e.g., such as magnesium battery cell 300. The battery case 390 is similar to that of FIGS. 13A-13B but having a different air interface 392. In FIG. 14, the battery case 390 includes an opening 394 in the battery case 390 (e.g., the first case body and/or second case body) with a liquid barrier layer 396 extending across the opening 394. The liquid barrier layer 396 may be a film or layer that is not supported by a mesh insert as in some of the previous embodiments. The liquid barrier layer 396 may be a waterproof or water impermeable membrane or a mesh with a sufficiently small pore size to permit gas (e.g. air) to pass therethrough but inhibit passage of water therethrough. The air interface 392 may be formed on one or both sides of the battery cell, for example, on the anode side, on the cathode side, or on both the anode and cathode sides of the battery cell.

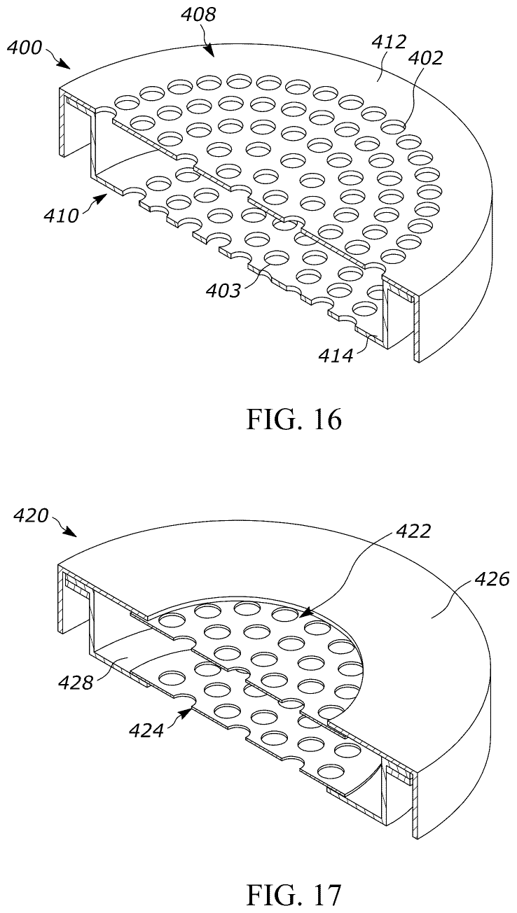

With respect to FIGS. 15 and 16, a battery case 400 is shown according to another embodiment for use with a magnesium battery cell, e.g., such as magnesium battery cell 300.

The battery case 400 is similar to the previous embodiments such that the differences are highlighted. In this embodiment, the battery case 400 does not include a central opening over which a mesh insert or liquid barrier layer extends. Instead, the battery case 400 includes air interfaces 408, 410 formed from plurality of openings 402, 403 in the battery case 400 itself (e.g., the first case body and/or second case body) over which a liquid barrier layer (e.g., like liquid barrier layer 396) extends. The first air interface 408 is in a first case body 412 of the battery case 400 and the second air interface 410 is in a second case body 414 of the battery case 400. Air is thus able to flow into and out of the battery case 400, and thus to or from the internal components of the battery cell, through either or both of the first or second air interface 408, 410. Air is thus able to enter and exit the battery case 406 from the cathode side and/or anode side of the battery cell. In other forms, the battery case 400 includes one of the first air interface 408 or second air interface 410 rather than both.

With respect to FIG. 17, a battery case 420 is shown that is similar to the battery case 360 of FIGS. 13A-13B such that the differences are highlighted. The battery case 420 includes two air interfaces 422, 424. The first air interface 422 is in a first case body 426 and the second air interface 424 is in a second case body 428. Air is thus able to flow into and out of the battery case 420, and thus to the internal components of the battery cell, through either or both of the first or second air interfaces 422, 424. Air is thus able to enter and exit the battery case 420 from the cathode side and/or anode side of the battery cell.

In some embodiments, the battery case 302 is formed of a metallic mesh having ultra-fine pores, for example, 2.75 angstroms or smaller. The pores may smaller than the size of a water molecule to inhibit water from flowing through the pores of the battery case 302. The metallic mesh may be, for example, a stainless steel mesh. The battery case 302 may include a waterproofing layer for further waterproofing, for example, a polymeric mesh, film or membrane.

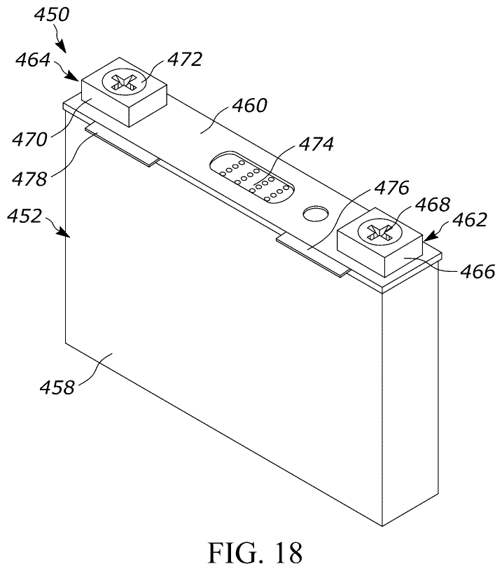

With respect to FIGS. 18-24, a magnesium battery cell 450 is provided according to another embodiment having a prismatic battery format. The battery cell 450 is similar in many respects to the embodiments discussed above such that the differences will primarily be discussed. In particular, the electrochemical reactions and operation of the magnesium battery cell 450 are similar to those discussed above and will not be repeated for conciseness and clarity. Regarding FIG. 18, the battery cell 450 has a case 452 that houses an anode-cathode laminate assembly 454 and electrolyte 456. The case 452 has a prism or rectangular shape.

The case 452 includes a main body 458 and an interface portion 460. The interface portion 460 mounts to an open end of the main body 458 to secure the anode-cathode laminate assembly 454 and electrolyte 456 in the case 452. In some examples, the main body 458 of the case 452 may be made of aluminum and/or stainless steel (e.g., 304, 316, or 17-4 PH stainless steels clad with aluminum, uncoated 304, 316, or 17-4 PH stainless steel alloys, anodized 6061/6063 or 3003 aluminum alloys). In some examples, the main body 458 is made of a mesh having a sufficiently small mesh size to permit airflow into and out of the battery cell 450 while inhibiting liquids (e.g., water) from passing through the main body 458 (e.g., 2.75 angstroms or smaller). In some embodiments, the main body 458 of the case 452 includes holes extending through the main body 458 with a liquid barrier layer (like liquid barrier layer 337) extending over the holes to permit gas to enter and exit the case 452 and inhibit liquid from passing therethrough. The holes may be disposed on one or more of the sides of the case 452.

The interface portion 460 includes a positive terminal 462 and a negative terminal 464. The positive terminal 462 and negative terminal 464 may be connected to conductors to connect the battery cell 450 to a load, a battery charger, or in an array with other battery cells 450 like the battery cell embodiments discussed above. The positive terminal 462 includes a mounting block 466 and a fastener 468 (e.g., a screw, stud, or bolt). The fastener 468 may be threaded to the mounting block 466 to secure and electrically connect a conductor (e.g., a wire, lug, busbar, etc.) to the positive terminal 462. The negative terminal 464 includes a mounting block 470 and a fastener 472 (e.g., a screw, stud, or bolt). The fastener 472 may be threaded to the mounting block 470 to secure and electrically connect a conductor (e.g., a wire, lug, busbar, etc.) to the negative terminal 464. In some embodiments, the positive and negative terminals 462, 464 include a threaded post to which a wing nut, washer, hex nut or other suitable hardware are threaded to secure and electrically connect the conductor thereto. The interface portion 460 may also include a cathode tab 476 and an anode tab 478. The cathode tab 476 may be soldered to the positive terminal 462 such that the fastener 468 electrically contacts the cathode tab 476 when secured to the mounting block 466. Similarly, the anode tab 478 may be soldered to the negative terminal 464 such that the fastener 472 electrically contacts the anode tab 478 when secured to the mounting block 470. As examples, the cathode tab 476 and anode tab 478 may be formed of pure aluminum, pure copper, or graphene-alloys of aluminum and copper (0.1-5% wt graphene or doped graphene).

The interface portion 460 of the case 452 may include a respirator 474. The respirator 474 permits gases to flow out of the case 452, for example, to inhibit over pressurization in the case 452. In some forms, the respirator 474 may permit gas (e.g., air) to enter the case 452 which is used in the chemical reactions of the magnesium air battery 450 as discussed above. The respirator 474 inhibits liquid from passing therethrough, to inhibit the electrolyte from leaking from the case 452 or liquid from outside of the case 452 from entering the case 452 through the respirator 474. As examples, the respirator 474 may be formed of PTFE, alumina (aluminum oxide) mesh, stainless steel mesh (304, 316, or 17-4 PH alloys), and/or nitrogen-doped graphene mesh.

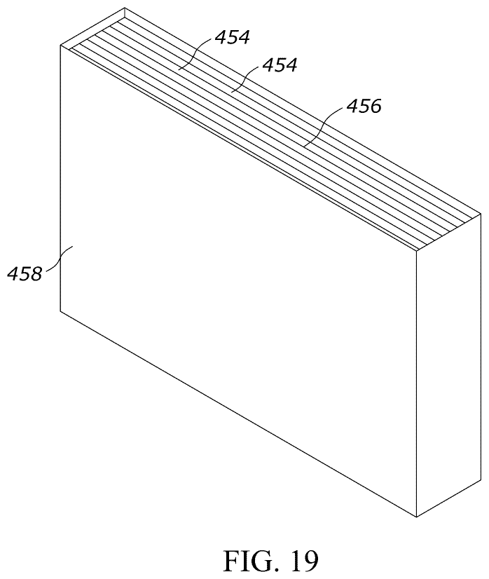

Regarding FIG. 19, the interface portion 460 of the case 452 is removed from the main body 458 showing multiple layers of the anode-cathode laminate assembly 454 disposed in the case 452. The electrolyte 456 solution is disposed in the case 452 in the free space about the anode-cathode laminate assemblies 454. The electrolyte solution may have a composition as discussed above, for example, a percent by weight ratio of 0.1-10% wt. NaCl, 0.1-5.0% wt. graphene oxide, and 85-99.8% wt. water.

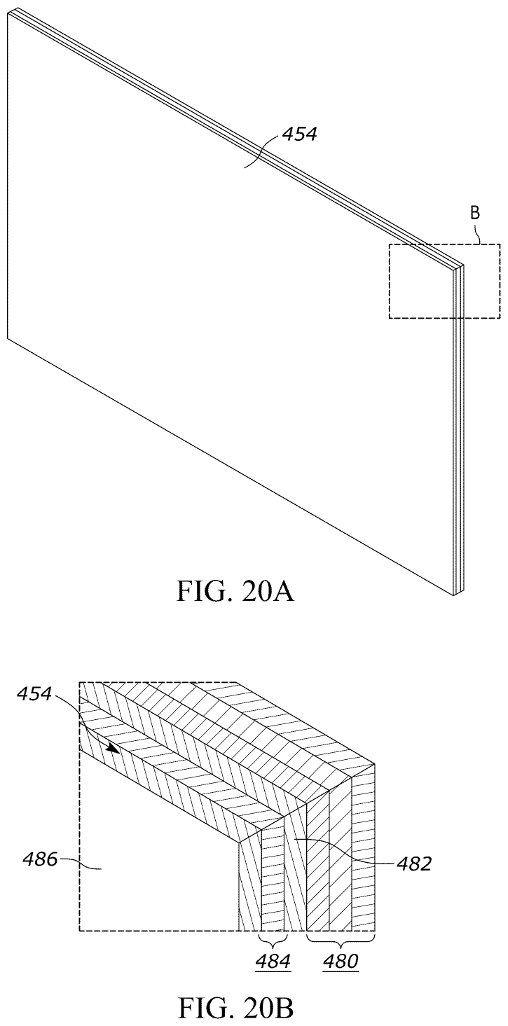

Regarding FIGS. 20A-20B, a single layer of the anode-cathode laminate assembly 454 is shown. FIG. 20B, shows an enlarged view of a corner of the anode-cathode laminate assembly 454 of FIG. 20A. The anode-cathode laminate assembly 454 includes a cathode assembly 480, a first separator sheet 482, an anode assembly 484, and a second separator sheet 486 which are all bonded or laminated together to form the anode-cathode laminate assembly 454. The first separator sheet 482 is between the cathode assembly 480 and the anode assembly 484. The electrolyte 456 solution flows in and may saturate (partially or fully) the first separator sheet 482 such that the electrolyte 456 solution is between the cathode assembly 480 and anode assembly 484. The first separator sheet 482 and the electrolyte 456 may have compositions similar to that described above with respect to the separator 308 and electrolyte 306 of the embodiment of FIGS. 8A-9B (e.g., with a solid separator and/or ionic salts with a complexing agent in the separator sheet and/or electrolyte). The second separator sheet 486 is laminated to the side of the anode assembly 484 opposite the first separator sheet 482 to separate the anode assembly 484 from the adjacent anode-cathode laminate assembly 454. The electrolyte 456 solution may also flow into and saturate the second separator sheet 486. As examples, the first and second separator sheets 482, 486 may be formed of nylon, polypropylene, PTFE, anodized aluminum foil or microfoil, aluminum foil or microfoil, alumina (aluminum oxide), cotton, nylon, polyesters, glass fibers, polyethylene, polypropylene, polyvinyl chloride films, and/or rubber.

The anode-cathode laminate assembly 454 may be layered with other anode-cathode laminate assemblies 454 when assembled into the case 452. In one form, the anode-cathode laminate assemblies 454 are layered such that the cathode assembly 480 contacts the second separator sheet 486 of the adjacent anode-cathode laminate assembly 454. In other forms, each layer of the anode-cathode laminate assemblies 454 is flipped or mirrored relative to the adjacent anode-cathode laminate assemblies 454 such that the cathode assembly 480 of one anode-cathode laminate assembly 454 faces the cathode assembly 480 of the adjacent anode-cathode laminate assembly 454 and the anode assembly 484 of the one anode-cathode laminate assembly 454 faces the anode assembly 484 of the other adjacent anode-cathode laminate assembly 454.

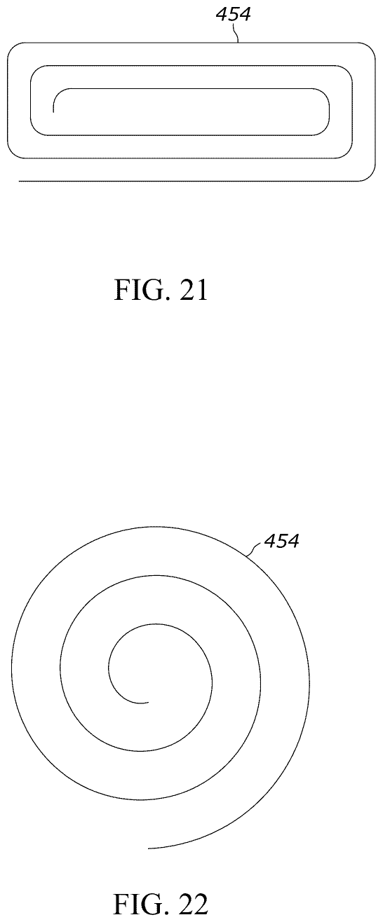

Regarding FIG. 21, in some forms, the battery cell 450 may include an anode-cathode laminate assembly 454 that is rolled about itself into what is known as a jellyroll configuration. As shown in FIG. 21, the anode-cathode laminate assembly 454 has a flat jellyroll configuration shaped to fit into the rectangular case 452 of the prismatic battery cell 450. Regarding FIG. 22, the anode-cathode laminate assembly 454 can be used in other battery configurations such as a cylindrical battery configuration discussed above by rolling the anode-cathode laminate assembly 454 into a cylindrical jellyroll configuration as shown in FIG. 22.

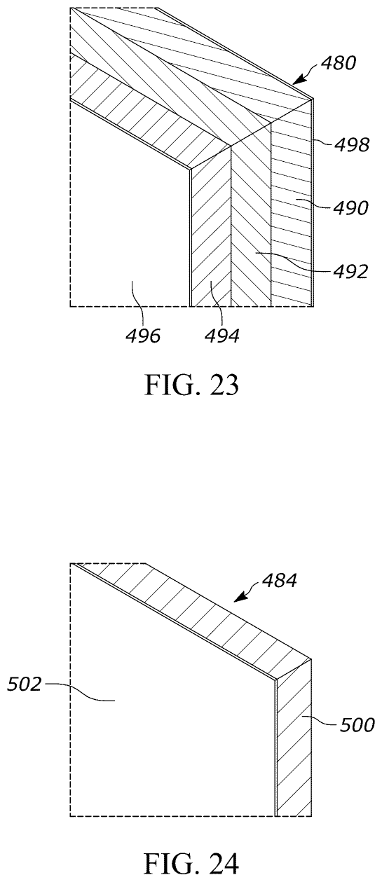

With respect to FIG. 23, the cathode assembly 480 of the anode-cathode laminate assembly 454 is shown. The cathode assembly 480 includes a cathode body 490 such as a magnesium layer, a liquid barrier layer 492, a collector layer 494, and a catalyst layer 496. The layers of the cathode assembly 480, while of a different structure, are formed of similar materials and have a similar function as discussed above with respect to the other battery cell embodiments. For example, the cathode body 490 corresponds to the frame 119 discussed above, the liquid barrier layer 492 corresponds to the liquid barrier 122, the collector layer 494 corresponds to the collecting layer 120, and the catalyst layer 496 corresponds to the catalyst layer 124. The cathode assembly 480 may further include a foil layer 498 bonded or laminated to the cathode body 490 opposite the liquid barrier layer 492. The foil layer 498 may be formed of, as examples, pure copper, pure aluminum, zinc foils, 304, 316, or 17-4 PH stainless steel, a graphene aluminum alloy, or a doped graphene aluminum alloy (e.g., doped with nitrogen, fluorine, phosphorus, and/or boron). In some embodiments, the foil layer 498 is a microfoil. The cathode tab 476 connects to the foil layers 498 of the cathode assemblies 480 to electrically connect the cathode assemblies 480 to the cathode tab 476.

In other forms, the cathode assembly 480 may include a porous cathode body 490 over which one or more layers of the liquid barrier 492, the collector 494, and a catalyst 496 are disposed similar to that discussed above with respect to the embodiment of FIGS. 10A-10B. For example, the cathode body 490 may be formed of a carbonaceous substrate. The materials of the liquid barrier layer 492, the collector layer 494, and/or the catalyst layer 496 may be mixed with a binder and disposed over the cathode body 490.

With respect to FIG. 24, the anode assembly 484 of the anode-cathode laminate assembly 454 is shown. The anode assembly 484 includes a magnesium layer 500 bonded or laminated to a foil layer 502. The magnesium layer 500 of the anode assembly 484 is similar to the anode 110 formed into a sheet. The magnesium layer 500 may be formed of materials similar to those discussed above with respect to the anode 110 (e.g., AZ31). The foil layer 502 may be formed of, as examples, pure copper, pure aluminum, zinc foils, 304, 316, or 17-4 PH stainless steel, a graphene aluminum alloy, or a doped graphene aluminum alloy (e.g., doped with nitrogen, fluorine, phosphorus, and/or boron). In some embodiments, the foil layer 502 is a microfoil. The anode tab 478 connects to the foil layers 502 of the anode assemblies 484 to electrically connect the anode assemblies 484 to the anode tab 478.

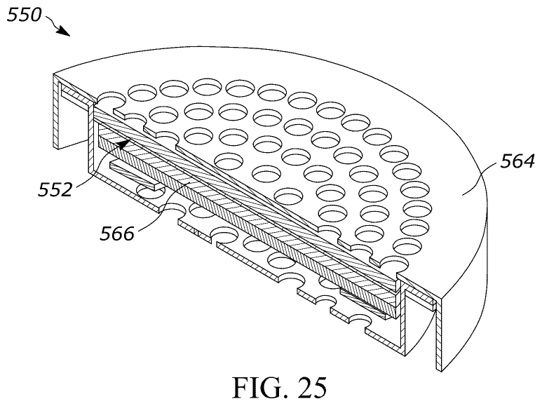

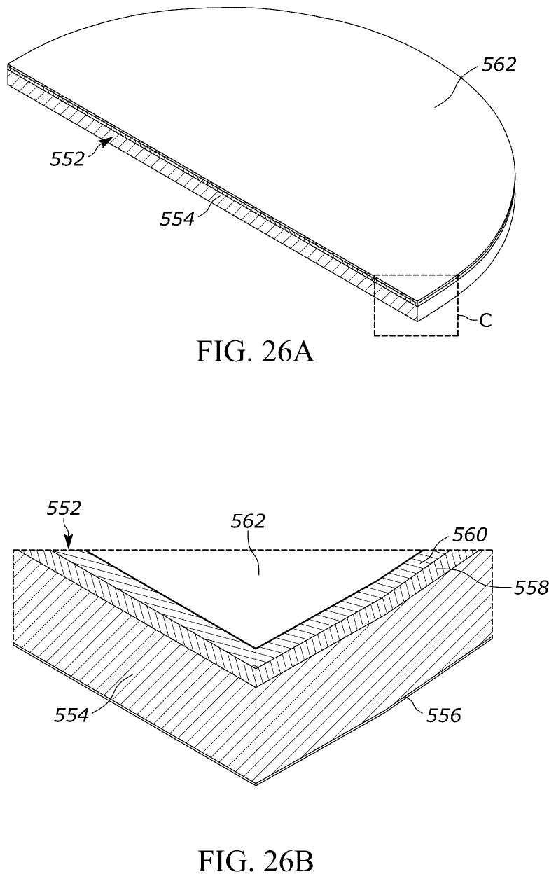

With respect to FIG. 25, a battery cell 550 is provided according to another embodiment. The battery cell 550 has a coin cell configuration and is similar to the embodiments previously discussed such that the differences are primarily highlighted. In the battery cell 550, the cathode assembly 552 of the battery cell 550 has a layered configuration rather than a concentric ring configuration as in some of the previous embodiments. With respect to FIGS. 26A-26B, the cathode assembly 552 of the battery cell 550 includes a cathode body 554, a current collector 556, a liquid barrier 558, a collector layer 560, and a catalyst layer 562. In this embodiment, the liquid barrier 558 is a layer disposed on the cathode body 554, the collector layer 560 is a layer disposed on the liquid barrier 558, and the catalyst layer 562 is a layer disposed on the collector layer 560. The current collector 556 may be a layer disposed on the cathode body 554 on the side opposite the liquid barrier 558 to contact a first case body 564 of battery cell 550. The catalyst layer 562 may contact a separator between the cathode assembly 552 and an anode 566. The cathode body 554, current collector 556, liquid barrier 558, collector layer 560, and catalyst layer 562 may be coextensive with one another and may have a disc shape. Each of these components may be formed of materials and have functions similar to those of the corresponding components of the previous embodiments described above.

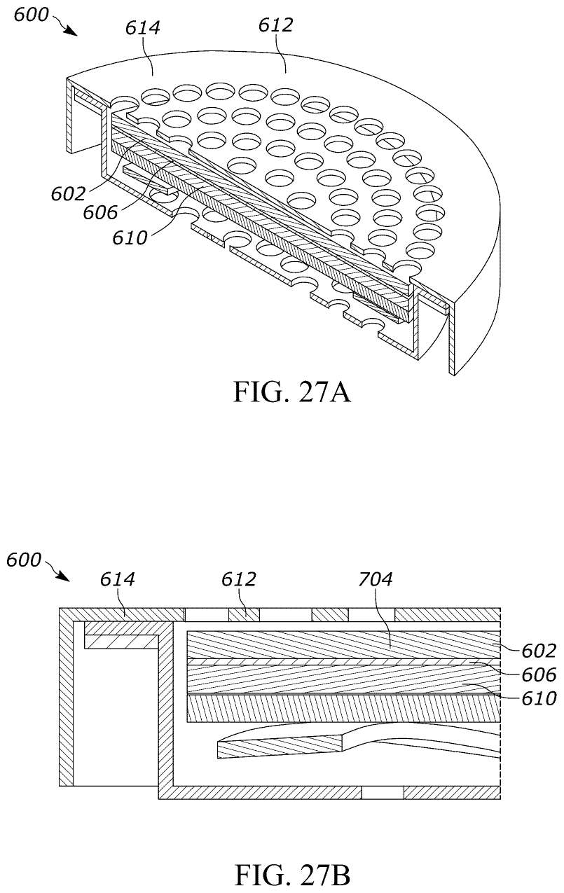

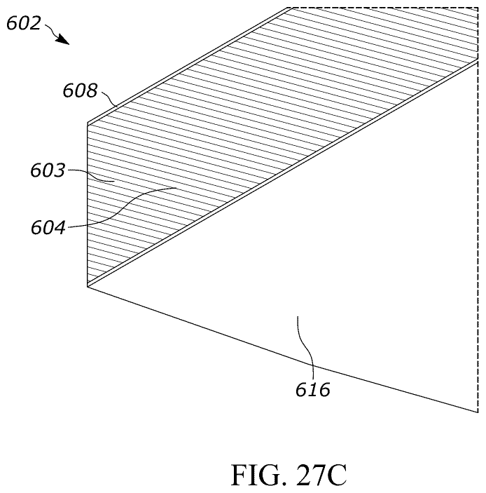

With respect to FIGS. 27A-27B, a battery cell 600 is provided having a cathode assembly 602 according to another embodiment. The battery cell 600 has a coin cell configuration and is similar to the embodiments previously discussed such that the differences are primarily highlighted. With reference also to FIG. 27C, the cathode assembly 602 includes a cathode 603 having a foam body 604 (e.g., a body including a plurality of pores). The foam body 604 may be a macro-foam, micro-foam, or nanofoam. The pores in the foam body 604 increase the reaction surface area of the cathode 603 used in the cathode oxygen reduction reactions as discussed below. The smaller the size of the pores, the greater the increase in reaction surface area. The foam body 604 may be a doped graphene or doped graphite nanofoam. The graphene or graphite nanofoam may be doped with, for example, nitrogen and/or phosphorus. Where the foam body 604 is a micro foam or a nanofoam, due to the pore size of such foams, the foam body 604 provides a liquid barrier that inhibits the electrolyte 606 (e.g., the liquid of the electrolyte) from flowing through the cathode assembly 602. The foam body 604 also has a high conductivity and efficiently conducts electrons to and from the electrolyte 606. Where the foam body 604 is a microfoam or nanofoam, the construction of the cathode assembly 602 may be simplified relative to the previous embodiments as foam body 604 can serve as the liquid barrier and collector (e.g., liquid barrier 340, collector 342) in addition to being the cathode. In other words, where the cathode 603 is a microfoam or nanofoam, the liquid barrier 340 and collector 342 may be eliminated.

The foam body 604 has pores that increase the specific surface area of the cathode 603, providing for a greater reaction surface area between the cathode 603 and the electrolyte 606. Oxygen gas is able to flow through the pores of the foam body 604 of the cathode 603. Due to the greater reaction surface area from the pores of the foam body 604, more oxygen gas is able to react with the electrolyte 606 at the reaction surface. Additionally, the greater reaction surface area of the cathode 603 permits more of the electrolyte 606 to interact with the oxygen gas of the cathode 603 during charge and discharge cycles, improving the efficiency of the reduction and oxidation reactions. In other words, increasing the reaction surface area speeds up the reaction kinetics at the cathode 603, which speeds up the recharging process.

The cathode assembly 602 includes a current collector 608 disposed on the foam body 604 opposite the anode 610. The current collector 608 may be similar to the current collectors of the previous embodiments, such as current collector 345. The current collector 608 may aid in efficiently conducting electrons between the foam body 604 and the cathode portion 612 of the battery case 614 which the cathode assembly 602 is urged against. The current collector 608 may be a foil or microfoil formed of aluminum (e.g., pure aluminum), a graphene aluminum alloy, or a doped-graphene aluminum alloy.

The cathode assembly 602 also includes a catalyst layer 616 disposed on the foam body 604 on the side of the foam body 604 facing the anode. The catalyst layer 616 may include a zinc phosphate coating on the anode-facing side of the foam body 604.

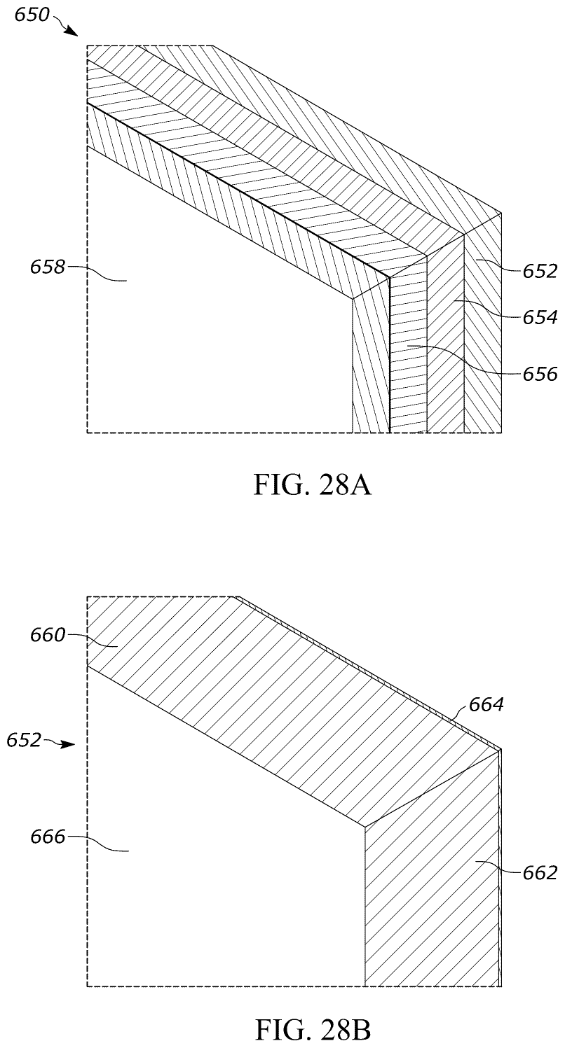

With respect to FIG. 28A, an anode-cathode laminate assembly 650 is provided that is similar in many respects to the anode-cathode laminate assembly embodiments discussed above such that the differences are primarily highlighted. The anode-cathode laminate assembly 650 includes a cathode assembly 652, a first separator sheet 654, an anode assembly 656, and a second separator sheet 658 which are all bonded or laminated together to form the anode-cathode laminate assembly 650. The first separator sheet 654, anode assembly 656, and second separator sheet 658 may be similar to the embodiments discussed above such that the discussion will not be repeated for conciseness and clarity. With reference also to FIG. 28B, the cathode assembly 652 is similar to the cathode assembly 602 of the coil cell configuration battery cell 600, but arranged in a sheet format for the anode-cathode laminate assembly 650 for use in prismatic and/or cylindrical battery cell formats. The cathode assembly 652 includes a cathode 660 having a foam body 662 (e.g., a nanofoam body), a current collector layer 664 on a side of the foam body 662 opposite the anode assembly 656, and a catalyst layer 666 on a side of the foam body 662 facing the anode assembly 656. The cathode assembly 652 functions and provides benefits similar to the cathode assembly 602 of the battery cell 600 discussed above.

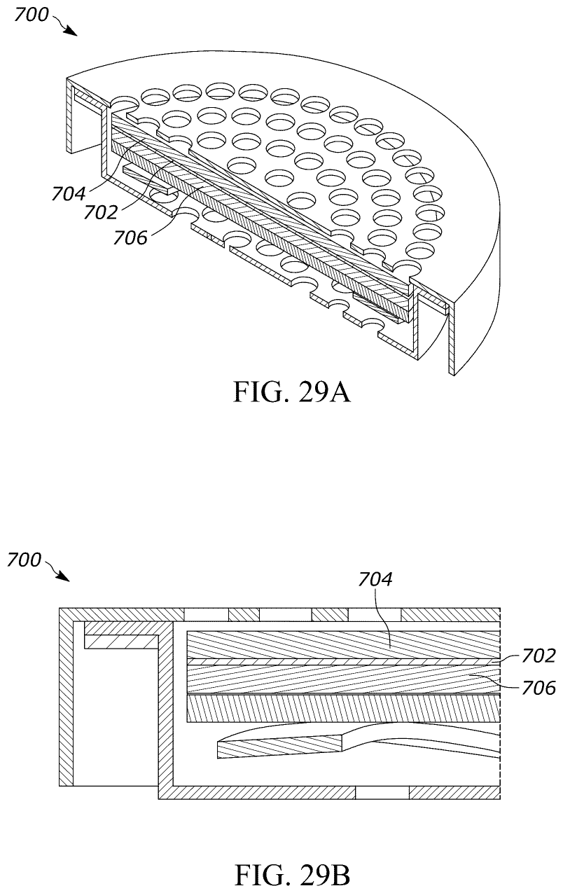

In some embodiments, the electrolyte of the battery cell (e.g., electrolyte 114) according to the above configurations is a solid state electrolyte rather than a liquid electrolyte saturated sheet. With reference to FIGS. 29A-29B, a battery cell 700 is provided in a coin cell format. The battery cell 700 is similar to the coin cell embodiments discussed above such that the differences are highlighted. The battery cell 700 includes a solid-state electrolyte 702 between the cathode assembly 704 and the anode 706. The solid-state electrolyte 702 may be a solid or gel material, such as an aerogel or hydrogel. For example, the electrolyte 702 may be a graphene aerogel, a graphene hydrogel, a doped graphene aerogel (e.g., carbon nanotube doped), a doped graphene hydrogel (e.g., carbon nanotube doped), a polyvinylidene fluoride gel, or a poly(ethylene oxide) (PEO) organic gel, a crosslinked polyacrylamide (PAM) hydrogel, a poly(ethylene oxide) (PEO) organic gel, a crosslinked polyacrylamide (PAM) hydrogel hybrid, and/or agar gel. As one example, the electrolyte 702 comprises 0.1-0.5% wt. agar gel with 0.1-3% wt. graphene and/or doped graphene powder. The electrolyte 702 functions similar to the electrolyte of the embodiments discussed above, facilitating electron/ion mobility between the cathode assembly 704 and the anode 706 during charge and discharge cycles. The electrolyte 702 also serves as a separator, inhibiting electrical shorts between the cathode assembly 704 and the anode 706 by spacing and electrically isolating the anode 706 and the cathode assembly 704.

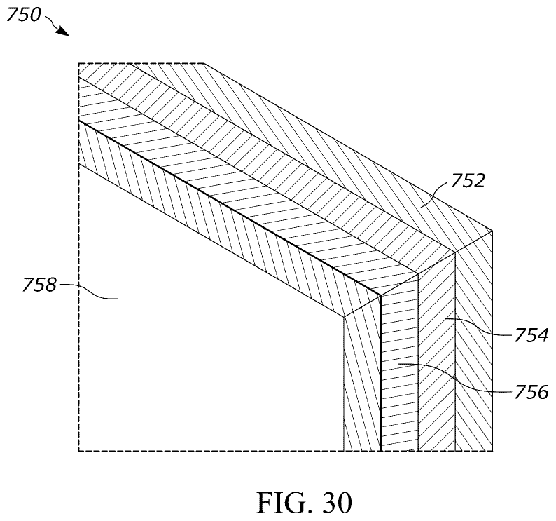

With respect to FIG. 30, an anode-cathode laminate assembly 750 is provided that is similar in many respects to the anode-cathode laminate assembly embodiments discussed above such that the differences are primarily highlighted. The anode-cathode laminate assembly 750 includes a cathode assembly 752, a first separator sheet 754, an anode assembly 756, and a second separator sheet 758 which are all bonded or laminated together to form the anode-cathode laminate assembly 750. In this embodiment, the first separator sheet 754 is a layer of a solid-state electrolyte. The second separator sheet 758 may also be a layer of solid-state electrolyte. The solid-state electrolyte may be a solid or gel material, such as an aerogel or hydrogel. For example, the solid-state electrolyte may be a graphene aerogel, a graphene hydrogel, a doped graphene aerogel (e.g., carbon nanotube doped), a doped graphene hydrogel (e.g., carbon nanotube doped), and/or agar gel. As one example, the solid-state electrolyte comprises 0.1-0.5% wt. agar gel with 0.1-3% wt. graphene and/or doped graphene powder. The solid-state electrolyte of the first separator sheet 754 functions similar to the electrolyte of the embodiments discussed above (e.g., electrolyte 456), facilitating electron/ion mobility between the cathode assembly 752 and the anode assembly 756 during charge and discharge cycles. The solid-state electrolyte of the first separator sheet 754 also serves as a separator, inhibiting electrical shorts between the cathode assembly 752 and the anode assembly 756 by spacing and electrically isolating the anode assembly 756 and the cathode assembly 704. In embodiments where the second separator sheet 758 is a solid-state electrolyte, the solid-state electrolyte of the second separator sheet 758 also serves as a separator, inhibiting electrical shorts between the anode-cathode laminate assembly 750 and the adjacent layer anode-cathode laminate assembly 750 or battery cell casing.

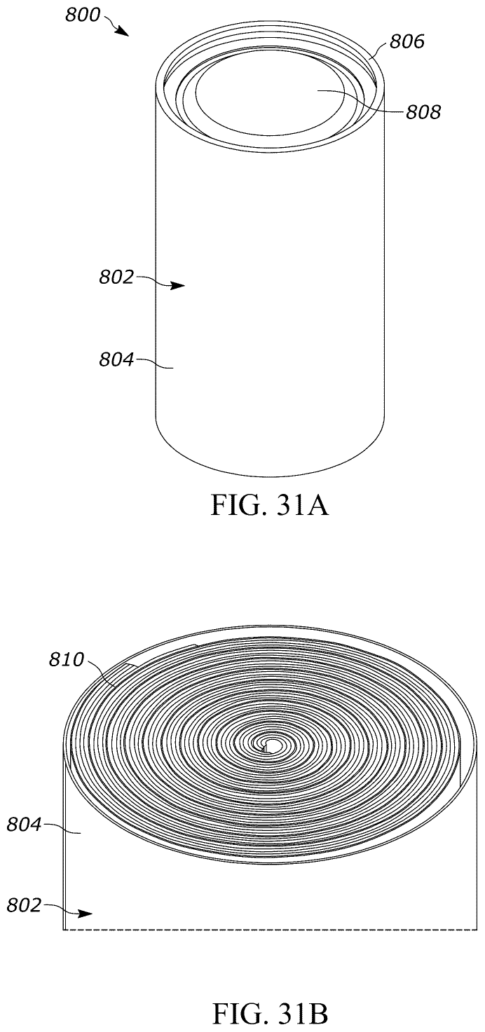

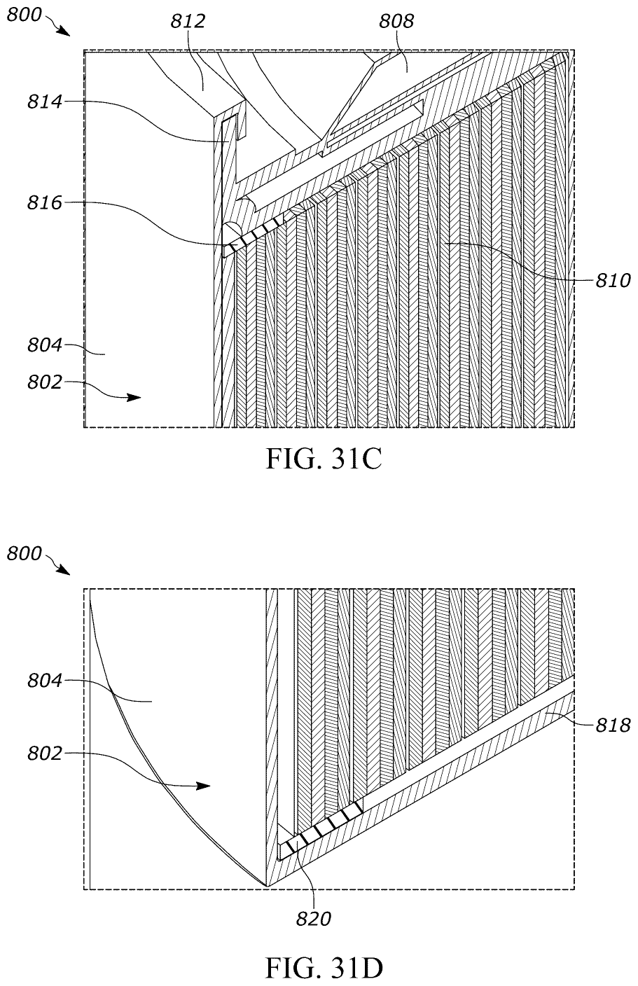

With respect to FIG. 31A-31D, a battery cell 800 having a cylindrical format is provided according to another embodiment. The battery cell 800 has a housing 802 including a cylindrical body 804 having an open end 806 and an end cap 808 to close the open end 806 of the cylindrical body 804. In some forms, the cylindrical body 804 has an open end 806 at both sides of the cylindrical body 804 that are closed by end caps 808. The housing 802 may be formed of an electrically insulating and thermally conductive material, for example, a steel and/or anodized aluminum alloys 6061, 6063, and/or 1100. The cylindrical body 804 and/or the end cap 808 may have a mesh construction or include microscopic pores sized to permit oxygen flow therethrough while inhibiting liquids (e.g., water) from passing therethrough.

With respect to FIG. 31B, the housing 802 may contain an anode-cathode laminate assembly 810 rolled into a cylindrical jellyroll configuration. The anode-cathode laminate assembly 810 may be any of the anode-cathode laminate assembly embodiments discussed above.

With respect to FIG. 31C, a closeup view of a portion of the battery cell 800 at the end cap 808 is provided. As shown, an end 812 of the cylindrical body 804 of the housing 802 is bent about (e.g., crimped) an outer wall 814 of the end cap 808 to secure the end cap 808 to the cylindrical body 804. The battery cell 800 includes a seal 816 between the anode-cathode laminate assembly 810 and the end cap 808. The seal 816 may be formed of an electrically-insulating material such as a rubber. The seal 816 may be a ring-shaped gasket or O-ring. The seal 816 seals aqueous electrolyte solution in the housing 802 (where present) and inhibits the electrolyte solution from leaking out of the housing 802 once the end cap 808 is secured to the cylindrical body 804. The seal 816 spaces the anode-cathode laminate assembly 810 from the end cap 808 and electrically-isolates the anode-cathode laminate assembly 810 from the end cap 808, for example, to inhibit unintentional electrical contact (e.g., electrical shorts) between the anode-cathode laminate assembly 810 and end cap 808. The cathode current collector of the anode-cathode laminate assembly 810 may be electrically connected to the end cap 808 to form the positive terminal of the battery cell 800. For example, a conductive tab (e.g., formed of aluminum (e.g., pure aluminum) and/or copper) may extend from the cathode current collector to the end cap 808.

With respect to FIG. 31D, a closeup view of a portion of the battery cell 800 at an end opposite end cap 808 is provided. As shown, the cylindrical body 804 has an end portion 818 closing the end of the cylindrical body 804. The battery cell 800 includes an insulator 820 between the anode-cathode laminate assembly 810 and the end portion 818. The insulator 820 may be formed of an electrically-insulating material such as a rubber. The insulator 820 may be a ring-shaped gasket or O-ring. The insulator 820 spaces the anode-cathode laminate assembly 810 from the end portion 818 and electrically-isolates the anode-cathode laminate assembly 810 from the end portion 818, for example, to inhibit unintentional electrical contact between the anode-cathode laminate assembly 810 and the cylindrical body 804. The anode current collector of the anode-cathode laminate assembly 810 may be electrically connected to the end portion 818 to form the negative terminal of the battery cell 800. For example, a conductive tab (e.g., formed of aluminum (e.g., pure aluminum) and/or copper) may extend from the anode current collector to the end portion 818.

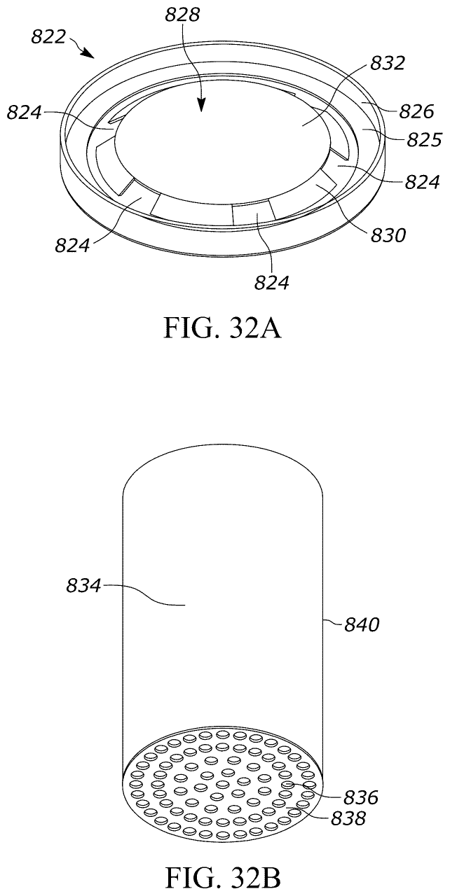

With respect to FIG. 32A, an end cap 822 for the battery cell 800 is provided according to another embodiment. The end cap 822 includes openings 824 formed therein to permit airflow into and out of the housing 802. For example, air may flow into and/or out of the battery cell 800 to facilitate the chemical reactions during a discharge or charge cycle. The openings 824 may also vent off-gasses generated during the chemical reactions. The end cap 822 includes a base 825 from which an outer wall 826 extends to be connected to the cylindrical body 804 as discussed above. The end cap 822 includes a terminal portion 828 which may be electrically connected to a load or battery charger when using the battery cell 800. The terminal portion 828 may be generally frustoconical, having a tapered wall 830 extending to an end wall 832. The openings 824 are in the tapered wall 830. The openings 824 may be spaced about the circumference of the tapered wall 830.

With respect to FIG. 32B, a cylindrical body 834 for the battery cell 800 is provided according to another embodiment where the cylindrical body 834 includes openings 836 to permit airflow into and out of the housing 802. The openings 836 are formed in the end portion 838. In some forms, the openings 836 are additionally or alternatively formed in the sidewall 840 of the cylindrical body 834. In some embodiments, a waterproof layer is disposed over the openings 836 to permit airflow through the openings 836 while inhibiting liquid (e.g., water) from passing therethrough. In some embodiments, the openings 836 are microscopic openings sized to permit airflow therethrough while inhibiting liquid (e.g., water) from passing therethrough. The cylindrical body 834 may be attached to the end cap 808 or end cap 822 to form the housing 802 of the battery cell 800. Where the end cap 822 and cylindrical body 834 include openings, air may flow through the battery cell 800. For example, air may flow into the battery cell 800 through the end cap 822 and out of the battery cell 800 through the cylindrical body 834 and vice versa.

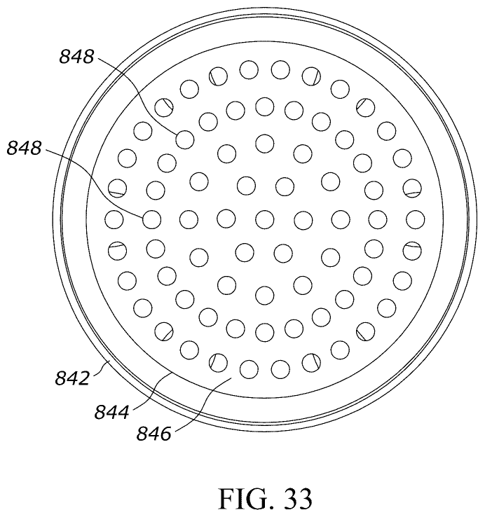

With respect to FIG. 33, a cylindrical body 842 for the battery cell 800 is provided with an open end 844 opposite the end cap. A liquid barrier layer 846 extends over the open end 844 to permit airflow therethrough while inhibiting liquid (e.g., water) from passing therethrough. The liquid barrier layer 846 may be a porous membrane having microscopic openings 848 sized such that air molecules (e.g., oxygen) are able to flow therethrough while inhibiting water molecules from passing therethrough.

In some embodiments, the electrolyte of the battery cell (e.g., electrolyte 114) according to the above configurations is a hybrid solid state electrolyte. As discussed above, one critical issue with typical magnesium-air batteries is their poor rechargeability. Poor rechargeability can largely be attributed to the passivating magnesium oxide (MgO), and magnesium hydroxide (Mg(OH)₂) generated at the anode during discharge (reaction equations of 1: Mg+1/2O2→MgO, and 2: Mg 30 2H2O→Mg(OH)2+H2). Both the magnesium oxide and hydroxide species are impermeable to Mg²⁺ ions, thereby inhibiting the redox reactions via poor mobility and transit of the magnesium Mg₂₊ ions needed for the redox reaction which drive the discharging and recharging processes. Another issue is that when magnesium is exposed to free water, the low current efficiency and severe hydrogen evolution side reaction lead to a large amount of irreversible loss of the magnesium ions at the anode. As such, the battery cell loses magnesium ions needed to participate in the discharging and charging reactions. Lastly, in aqueous electrolytes, the charge process, or the oxygen evolution reaction, at the cathode requires hydroxide (OH—) ions (Reaction Equation: 4OH— 4e↔O2+2H2O). To maintain the reactivity of the cathode, a concentrated, alkaline, aqueous electrolyte may be used. Use of such an electrolyte, however, generally leads to the passivation of the magnesium anode due to the formation of magnesium hydroxide species as mentioned above, as well as irreversible loss of magnesium Mg2+ ions as the stripped magnesium Mg2+ ions generated during discharge then react with the hydroxide OH-ions in the aqueous electrolyte to form magnesium hydroxide precipitates. A hybrid electrolyte addresses the above issues as discussed below.

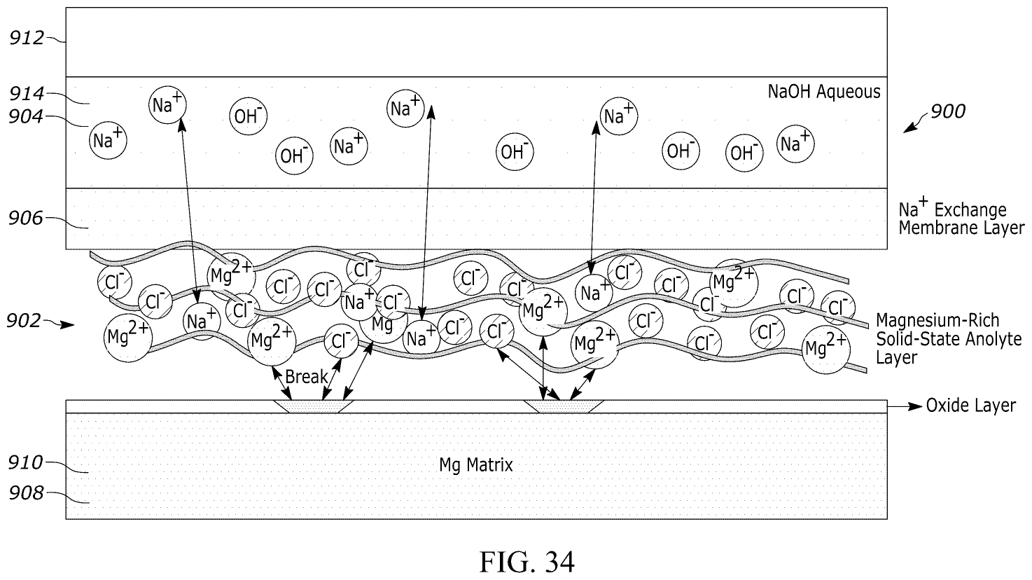

With respect to FIG. 34, a schematic diagram of a hybrid solid state electrolyte 900 is provided that is between the anode 910 and the cathode 912 of the battery cell (e.g., those discussed above). The hybrid solid state electrolyte 900 includes one or more anolyte layers 902, one or more catholyte layers 904, and one or more ion exchange membranes 906 between the anolyte layer(s) 902 and the catholyte layer(s) 904. The catholyte layer 904 may be adjacent the cathode body and the anolyte layer 902 may be adjacent the anode body. As one example, the anolyte layer 902 includes a base 908 comprising a magnesium alginate saturated with magnesium chloride and sodium chloride anolyte. As one example, the ion exchange membrane 906 includes a polyvinylidene difluoride-sulfonated poly(ether ether ketone)-Polyvinylpyrrolidone ion exchange membrane. As one example, the catholyte layer 904 includes substrate (for example, nylon, polypropylene, PTFE, anodized aluminum foil or microfoil, aluminum foil or microfoil, alumina (aluminum oxide), cotton, nylon, polyesters, glass fibers, polyethylene, polypropylene, polyvinyl chloride films, and/or rubber) saturated with an aqueous sodium hydroxide.

The anolyte layer 902 may be configured to provide an alternative reaction mechanism favoring more reversible discharge products which have a lower thermodynamic energy barrier to dissolution. Providing such an alternative reaction mechanism enhances the reversibility of the recharging process as the recharging chemical reactions have a lower barrier to proceeding and can thus proceed more readily. In some forms, the anolyte layer 902 may include multiple different anolyte layers to provide such an alternative reaction mechanism. Additionally, the anolyte layer may contain, or a substrate of the base 908 of the anolyte layer 902 may be formed of, a corrosion-inhibiting material(s) to suppress the corrosion reactions of the anode 910, ensuring there is ample reaction surface area free during discharge and recharge. Further to this, as discussed above regarding the corrosive hydrogen evolution reaction, the anolyte layer 902 may also suppress the hydrogen evolution reaction via the promoting of an alternative reaction pathway that occurs more readily than the hydrogen evolution reaction and as such, may inhibit the hydrogen evolution reaction from occurring. Additionally, the anolyte layer 902 may contain reaction catalyzing agents to help promote the discharge and/or recharging reactions. One example would be magnesium chloride, which ensures there is a saturation of magnesium ions in addition to what is present at the anode 910, which are then able to migrate between the anode 910 and anolyte solution as required to promote the discharge and recharging reactions, ensuring there is a surplus of free magnesium ions.

The ion exchange membrane 906 situated between the anolyte layer 902 and catholyte layer 904 is configured as a molecular filter to permit passage of certain ions therethrough while inhibiting passage of other ions. For instance, the ion exchange membrane permits certain ions to freely migrate between the anolyte layer 902 and catholyte layer 904 as needed to promote the alternative intermediary reaction steps during discharging and recharging. Further to this, the ion exchange membrane 906 is also configured such that other reaction products which may otherwise inhibit the overall reactions during charging and discharging remain isolated to their respective side(s) of the ion exchange membrane 906. In some forms, the ion exchange membrane 906 includes multiple different layers of ion exchange membranes to achieve the above effects.

The catholyte layer 904 is configured to provide an alternative reaction mechanism favoring more reversible discharge products at the cathode 912 which have a lower thermodynamic energy barrier to dissolution/decomposition. Providing such an alternative reaction mechanism enhances the reversibility of the recharging process as the recharging chemical reactions have a lower barrier to proceeding and can thus proceed more readily. In some forms, the catholyte layer 904 includes multiple different catholyte layers to provide such an alternative reaction mechanism. Additionally, the catholyte layer 904 may contain, or the base substrate 914 of the catholyte layer may be formed of, a corrosion-inhibiting material(s) to suppress the corrosion reactions of the cathode 912, ensuring there is ample reaction surface area free during discharge and recharge. Additionally, the catholyte layer 904 may contain reaction catalyzing agents, to help promote the discharge and/or recharging reactions. One such example is sodium hydroxide, which helps promote the oxygen reduction/oxygen evolution reaction at the air cathode 912.

More specifically, during the discharge process, the stripped magnesium Mg2+ ions are conducted into the solid anolyte layer 902 from the surface of anode 910, and the desired ions in the solid anolyte layer 902 are conducted into the catholyte layer 904 by passing through the ion exchange membrane 906 to complete the circuit. The recharging process runs in reverse, whereby the desired ions in the catholyte layer 904 pass through the ion exchange membrane 906 into the anolyte layer 902, and magnesium Mg2+ ions redeposit on the surface of the anode 910. In saturating the anolyte layer 902 with ionic magnesium salts and/or ionic lithium salts with sodium chloride, any contained chloride Cl— ions from these species in the solid anolyte layer 902 can migrate to the anode 910 surface and destroy the passivating oxide layer on the anode surface to reduce the anodic polarization during cycles. This also helps keep the anode reaction surface clean of passivating deposits to ensure the discharge and recharge reactions can readily occur. The ion exchange membrane 906 may be configured to have a high conductivity of desired ions, such as sodium Na+ ions, and a poor conductivity of Mg2+ ion and OH— ions. So configured, the ion exchange membrane 906 inhibits the intermingling of the magnesium Mg2+ ions and hydroxide OH— ions during charging and discharging by isolating them from each other on either side of the ion exchange membrane 906 (e.g., keeping the magnesium Mg2+ ions on the anolyte side of the ion exchange membrane 906 and the hydroxide OH— ions on the catholyte side of the ion exchange membrane 906) so the irreversible magnesium hydroxide species do not form. Further, the ion exchange membrane 906 may be configured to have a low water permeability to protect the anode 910 from water erosion and the corrosive hydrogen evolution reaction. The catholyte layer 904 has a high oxygen reduction reaction/oxygen evolution reaction reactivity at the air cathode 912, being rich in dissolved oxygen, and promoting the more efficient 4 electron cathode reaction of O2+2H2O +4 e-↔4 OH—.

In the various embodiments discussed above, the components of the magnesium battery cell having doped graphite or doped graphene (such as, for example, the collecting layer 120, electrolyte 114, liquid barrier 334, liquid barrier 340, current collector 345, current collector 352, cathode tab 476, anode tab 478, foil layer 498, foil layer 502, foam body 604, solid-state electrolyte 702) may be doped with a doping agent to increase the electrical and thermal conductivity of the component. The doping agents with which the graphite or graphene is doped may include one or more of elemental dopants, acid dopants, and compound dopants. Elemental dopants are doping agents that are chemical elements, for example, nitrogen, fluorine, boron, chlorine, sulfur, and/or phosphorus. Acid dopants are doping agents that are acids, for example, sulfuric acid, hydrochloric acid, phosphoric acid, nitric acid, and trifluoromethanesulfonic acid. Compound dopants are doping agents that are a chemical compound, for example, tetrafluorotetracyanoquinodimethane, polyethyleneimine, ammonia, 2,3,5,6-tetrafluoro-7,7,8,8-tetracyanoquinodimethane, gold chloride).

In another aspect, a method is provided for making the battery cells according to the above embodiments. The method includes forming an anode body of magnesium, such as an anode body according to any of the embodiments described herein. The step of forming the anode body may include, for example, forming the anode body of a magnesium alloy having a percent by weight ratio in a range of about 77.0-99.8% wt. magnesium, 0.1-8.0% wt. aluminum, 0.1-5.0% wt. zinc, 0-5.0% wt manganese, and 0-5.0% wt. iron. The method includes forming a cathode body, such as a cathode body according to any of the embodiments described herein. The method includes positioning the anode body and the cathode body in a housing having at least a portion permeable to air and with an electrolyte between the anode and the cathode. In some forms, the method includes saturating a separator sheet with an electrolyte solution of the electrolyte and positioning the saturated separator sheet between the anode body and cathode body. In some forms, the method includes forming a solid state electrolyte and positioning the solid state electrolyte between the anode body and cathode body.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A battery comprising:
an anode having an anode body formed of a magnesium alloy having a percent by weight ratio in a range of about 77.0-99.8% wt. magnesium, 0.1-8.0% wt. aluminum, 0.1-5.0% wt. zinc, 0-5.0% wt manganese, and 0-5.0% wt. iron;
a cathode including a cathode body; and
an electrolyte between the anode and the cathode.

2. The battery of claim 1 wherein the magnesium alloy is at least one of AZ31, AZ61, and MA8M06.

3. The battery of claim 1 wherein the magnesium alloy of the anode body further comprises a percent by weight ratio of one or more of 0.1-2% wt. germanium, 0.1-5% wt. calcium, 0.1-3% wt. samarium, 0.1-5% wt. gallium, and 0.1-3% wt. indium.

4. The battery of claim 1 wherein the magnesium alloy of the anode body further comprises a percent by weight ratio in a range of about 0.7-2.0% wt. manganese and/or 0.1-0.7% wt. iron.

5. The battery of claim 1 wherein the anode body includes a foam body formed of the magnesium alloy.

6. The battery of claim 1 wherein the cathode body includes a foam body.

7. The battery of claim 6 wherein the foam of the cathode body comprises graphene, graphite, doped graphene, or doped graphite.

8. The battery of claim 6 wherein the foam is a nanofoam.

9. The battery of claim 1 wherein the cathode includes a liquid barrier between the electrolyte and the cathode body, the liquid barrier inhibiting a liquid of the electrolyte from contacting the cathode body.

10. The battery of claim 1 wherein the cathode further includes a collecting layer disposed at an interface of the cathode and the electrolyte, wherein the collecting layer includes openings to permit fluid flow therethrough.

11. The battery of claim 10 wherein the collecting layer of the cathode includes one or more of a nickel, carbon, graphite, graphene, doped graphite, and a doped graphene.

12. The battery of claim 11 wherein the doped graphite or doped graphene are doped with an elemental doping agent.

13. The battery of claim 1 wherein the cathode includes porous substrate, wherein the cathode includes at least one of a catalyst layer, waterproofing layer, and collecting layer disposed over the porous substrate.

14. The battery of claim 13 wherein the porous substrate comprises a carbonaceous substrate.

15. The battery of claim 1 wherein the cathode body has a percent by weight ratio in a range of about 0-90% wt. doped-graphene and/or manganese oxide, 0-10% wt. carbon substrate, 0-10% binding agent.

16. The battery of claim 1 wherein the cathode body has a percent by weight ratio in a range of about 0-90% wt. graphene and/or a crushed graphene nanofoam, 0-10% wt. carbon substrate, and 0-10% wt. binding agent.

17. The battery of claim 1 further comprising a battery cell terminal, wherein the cathode includes a current collecting layer in electrical communication with the battery cell terminal, wherein the current collecting layer of the cathode includes one or more of aluminum and copper.

18. The battery of claim 1 wherein the anode includes an anode current collector disposed over a side of the anode body opposite the electrolyte, wherein the cathode includes a cathode current collector disposed over a side of the cathode body opposite the electrolyte.

19. The battery of claim 18 wherein the anode current collector includes one of more of aluminum, copper, aluminum-graphene, aluminum-doped graphene, copper-graphene, copper-doped graphene, carbon, graphite, graphene, and doped graphene,
wherein the cathode current collector includes one or more of aluminum, copper, aluminum-graphene, aluminum-doped graphene, copper-graphene, copper-doped graphene alloy, carbon, graphite, graphene, and doped graphene.

20. The battery of claim 1 wherein the cathode includes a catalyst disposed at an interface of the cathode with the electrolyte.

21. The battery of claim 20 wherein the catalyst includes one or more of a zinc phosphate and a manganese oxide.

22. The battery of claim 1 wherein the electrolyte is a solution having a percent by weight ratio of 0.1-10% wt. sodium chloride, 0.1-5.0% wt. graphene or doped graphene, and 85-99.8% wt. water.

23. The battery of claim 1 wherein the electrolyte comprises a solid-state aerogel and/or hydrogel.

24. The battery of claim 23 wherein the electrolyte is a graphene aerogel, a graphene hydrogel, a doped graphene aerogel, a doped graphene hydrogel, and/or agar gel.

25. The battery of claim 24 wherein the electrolyte is a graphene aerogel or graphene hydrogel doped with carbon nanotubes.

26. The battery of claim 1 further comprising a separator between the anode and the cathode, the separator being saturated with the electrolyte.

27. The battery of claim 26 wherein the separator includes at least one of a hydrogel and an aerogel.

28. The battery of claim 1 wherein the electrolyte comprises a solution having a percent by weight ratio of about 0.1-20% wt. sodium chloride, 0.1-70% wt. ionic salt with a complexing agent, and 10-99.8% wt. water.

29. The battery of claim 28 wherein the ionic salt includes a central metal ion including one or more of lithium, magnesium, potassium, sodium and zinc, wherein the complexing agent includes one or more of nitrate, ammonium, sulfate, phosphate, acetate, chloride, and hydrogen.

30. The battery of claim 1 wherein the electrolyte comprises a solution having a percent by weight ratio of about 0.1-20% wt. sodium chloride, 30-70% wt. ionic magnesium salts with a complexing agent, and 10-69.9% wt. water.

31. The battery of claim 1 wherein the electrolyte comprises a solution having a percent by weight ratio of about 0.1.-20% wt. sodium chloride, 20-70% wt. ionic lithium salts with a complexing agent, and 10-79.9% wt. water.

32. The battery of claim 1 wherein the electrolyte comprises a solution having a percent by weight ratio of about 0-10% wt. sodium chloride, 20-50% wt. ionic magnesium salt with a complexing agent, 5-30% wt. ionic lithium salts with a complexing agent, and 10-75% wt. water.

33. The battery of claim 26 wherein the separator includes a percent by weight ratio in a range of about 0.1-10% wt. agar, 0.1-20% sodium chloride, 0.1-60% wt. ionic salt with a complexing agent, 0-10% wt. doped graphene powder, and 70-99.7 water,
wherein the ionic salt includes a central metal ion including one or more of lithium, magnesium, potassium, sodium and zinc, wherein the complexing agent includes one or more of nitrate, ammonium, sulfate, phosphate, acetate, chloride, and hydrogen.

34. The battery of claim 1 further comprising a housing about the cathode, the housing including openings to permit air to flow to and from the cathode.

35. The battery of claim 34 wherein the housing includes a liquid barrier layer over the openings to inhibit fluid from flowing through the openings of the housing.

36. The battery of claim 34 wherein the openings of the housing are sized to permit oxygen to pass through the housing and to inhibit water from passing through the housing.

37. The battery of claim 1 wherein the cathode body of the cathode is formed of a magnesium alloy having a percent by weight ratio in a range of about 92.0-97.9% wt. magnesium, 2.0-7.2% wt. aluminum, and 0.1-5.0% wt. zinc.

38. The battery of claim 37 wherein the magnesium alloy is at least one of AZ31, AZ61, and MA8M06.

39. The battery of claim 1 wherein the anode is a first layer in a laminate assembly and the cathode is a second layer in the laminate assembly.

40. The battery of claim 1 further comprising a housing about the anode, cathode and electrolyte, the housing having a plurality of microscopic openings sized to permit air to flow through the housing and inhibit water from flowing through the housing.

41. The battery of claim 40 wherein the plurality of microscopic openings of the housing have a diameter of 2.75 angstroms or less.

42. The battery of claim 1 further comprising:
a housing including at least one opening; and
a liquid barrier layer extending across the at least one opening, the liquid barrier layer permitting air to flow therethrough and inhibiting liquid from flowing therethrough.

43. The battery of claim 1 wherein the battery has a cylindrical format, pouch format, prismatic format, or a coin cell format.

44. A battery cell comprising:
an anode having a magnesium anode body;
a cathode having a cathode body;
a hybrid solid-state electrolyte between the anode body and the cathode body, the hybrid solid-state electrolyte including:
at least one anolyte layer;
at least one catholyte layer; and
at least one ion exchange membrane between the at least one anolyte layer and the at least one catholyte layer.

45. The battery cell of claim 44 wherein the at least one anolyte layer includes a base comprising a magnesium alginate saturated with magnesium chloride and sodium chloride anolyte.

46. The battery cell of claim 44 wherein the at least one ion exchange membrane includes a polyvinylidene difluoride-sulfonated poly(ether ether ketone)-Polyvinylpyrrolidone ion exchange membrane.

47. The battery cell of claim 44 wherein the at least one catholyte layer has substrate formed of one or more of: nylon, polypropylene, PTFE, anodized aluminum foil or microfoil, aluminum foil or microfoil, alumina (aluminum oxide), cotton, nylon, polyesters, glass fibers, polyethylene, polypropylene, polyvinyl chloride films, and rubber;
wherein the substrate is saturated with an aqueous sodium hydroxide.

48. The battery cell of claim 44 wherein the magnesium anode body is formed of at least 99% pure magnesium.

49. The battery cell of claim 44 wherein the magnesium anode body is formed of a magnesium alloy having a percent by weight ratio in a range of about 77.0-99.8% wt. magnesium, 0.1-8.0% wt. aluminum, 0.1-5.0% wt. zinc, 0-5.0% wt manganese, and 0-5.0% wt. iron.

50. A method of making a battery cell, the method comprising:
forming an anode body of a magnesium alloy having a percent by weight ratio in a range of about 77.0-99.8% wt. magnesium, 0.1-8.0% wt. aluminum, 0.1-5.0% wt. zinc, 0-5.0% wt manganese, and 0-5.0% wt. iron;
forming a cathode body; and
positioning the anode body and the cathode body in a housing having at least a portion permeable to air with an electrolyte between the anode body and the cathode body.

51. The method of claim 50 further comprising saturating a separator sheet with an electrolyte solution of the electrolyte and positioning the saturated separator sheet between the anode body and cathode body.
